(19) United States
(12) Patent Application Publication
(10) Pub. No.: US 2021/0372335 A1
(43) Pub. Date: Dec. 2, 2021

(54) CONTROL DEVICE AND METHOD FOR CONTROLLING INTERNAL COMBUSTION ENGINE

(71) Applicant: DENSO CORPORATION, Kariya-city (JP)

(72) Inventor: Daisuke NAKANISHI, Kariya-city (JP)

(21) Appl. No.: 17/404,317

(22) Filed: Aug. 17, 2021

Related U.S. Application Data
(63) Continuation of application No. PCT/JP2020/000823, filed on Jan. 14, 2020.

(30) Foreign Application Priority Data
Feb. 22, 2019 (JP) 2019-030505

(51) Int. Cl. F02D 41/00; F02D 35/02

(52) U.S. Cl. CPC F02D 41/0052; F02D 2200/021; F02D 35/025

(57) ABSTRACT

A wall temperature acquisition unit acquires a wall temperature of an internal combustion engine. A wall temperature adjustment unit adjusts the wall temperature. A ratio adjustment unit adjusts a gas ratio that is acquired by dividing a mass flow amount of gas supplied to the internal combustion engine by a mass flow amount of fuel supplied to the internal combustion engine. The wall temperature adjustment unit performs a low wall temperature control to maintain the wall temperature at a low temperature when the internal combustion engine is at a high load and a high wall temperature control to maintain the wall temperature at a high temperature when the internal combustion engine is at a low load. The ratio adjustment unit adjusts the gas ratio based on the wall temperature, when switching between the low wall temperature control and the high wall temperature control is performed.

### CROSS REFERENCE TO RELATED APPLICATION

The present application is a continuation application of International Patent Application No. PCT/JP2020/000823 filed on Jan. 14, 2020, which designated the U. S. and claims the benefit of priority from Japanese Patent Application No. 2019-030505 filed on Feb. 22, 2019. The entire disclosures of all of the above applications are incorporated herein by reference.

### TECHNICAL FIELD

The present disclosure relates to a control device for an internal combustion engine. The present disclosure further relates to a method for controlling an internal combustion engine.

### BACKGROUND

A vehicle is equipped with a control device for controlling an internal combustion engine. The control device controls, for example, a flow amount and a temperature of cooling water flowing through the internal combustion engine to maintain the internal combustion engine at an appropriate temperature.

### SUMMARY

According to an aspect of the present disclosure, a wall temperature acquisition unit is configured to acquire a wall temperature of the internal combustion engine. A wall temperature adjustment unit is configured to adjust the wall temperature. A ratio adjustment unit is configured to adjust a gas ratio, which is a ratio acquired by dividing a mass flow amount of gas supplied to the internal combustion engine by a mass flow amount of fuel supplied to the internal combustion engine. The wall temperature adjustment unit is configured to perform a low wall temperature control to maintain the wall temperature at a low temperature when the internal combustion engine is operated at a high load and a high wall temperature control to maintain the wall temperature at a high temperature when the internal combustion engine is operated at a low load. The ratio adjustment unit is configured to adjust the gas ratio based on the wall temperature acquired by the wall temperature acquisition unit, when switching between the low wall temperature control and the high wall temperature control is performed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram schematically showing a configuration of a control device according to a first embodiment and an internal combustion engine and the like as a control target thereof.

FIG. 2 is a diagram showing an exterior of a flow control valve.

FIG. 3 is a diagram schematically showing an internal configuration of the flow control valve.

FIG. 4 is a view showing a change in opening ratios of the flow control valve.

FIG. 5 is a diagram schematically showing a configuration of a control device according to the first embodiment.

FIG. 6 is a view for explaining switching between a low wall temperature control and a high wall temperature control.

FIG. 7 incudes views showing a change in a wall temperature and the like associated with an operation of the flow control valve.

FIG. 8 is a view showing a relationship among a flow amount and temperature of cooling water and the wall temperature of the internal combustion engine.

FIG. 9 is a flowchart showing a flow of processing executed by the control device according to the first embodiment.

FIG. 10 is a flowchart showing a flow of processing executed by the control device according to the first embodiment.

FIG. 11 is a view showing a relationship between a position of a valve body in the flow control valve and a flow amount ratio.

FIG. 12 is a view showing a relationship between a rotation speed of the internal combustion engine and the flow amount of cooling water.

FIG. 13 is a view showing a relationship among the rotation speed and an intake air amount of the internal combustion engine, and the reference wall temperature of the internal combustion engine.

FIG. 14 includes a view showing a relationship between a flow amount correction coefficient and the flow amount of cooling water and a view showing a relationship between a water temperature correction coefficient and a temperature of the cooling water.

FIG. 15 includes views showing a relationship between the wall temperature and a gas ratio at a combustion limit.

FIG. 16 includes views showing a relationship between the wall temperature and a gas ratio at a combustion limit.

FIG. 17 includes time charts showing an example of a time change in the air flow amount and the like.

FIG. 18 is a diagram schematically showing a configuration of a control device according to a second embodiment and an internal combustion engine and the like as a control target thereof.

FIG. 19 is a diagram schematically showing a configuration of a control device according to the second embodiment.

FIG. 20 is a view for explaining switching between a low wall temperature control and a high wall temperature control.

FIG. 21 incudes views showing a change in a wall temperature and the like associated with an operation of the flow control valve.

FIG. 22 is a view showing a relationship among a flow amount and temperature of cooling water and the wall temperature of the internal combustion engine.

FIG. 23 is a flowchart showing a flow of processing executed by the control device according to the second embodiment.

FIG. 24 is a view showing a relationship between a rotation speed of a water pump and the flow amount of cooling water.

FIG. 25 includes time charts showing an example of a time change in the air flow amount and the like.

FIG. 26 is a diagram schematically showing a configuration of an internal combustion engine and the like according to a third embodiment.

### DETAILED DESCRIPTION

As follows, examples of the present disclosure will be described.

A vehicle is equipped with a control device for controlling an internal combustion engine. The control device controls, for example, a flow amount and a temperature of cooling water flowing through the internal combustion engine to maintain the internal combustion engine at an appropriate temperature.

According to an example of the present disclosure, a control is performed to change a temperature of cooling water according to a load of the internal combustion engine.

In this control, in a low load state where the load of the internal combustion engine is low, the temperature of the cooling water is controlled at a high value, and in a high load state where the load of the internal combustion engine is high, the temperature of the cooling water is controlled at a low value. This control enables to restrict occurrence of knocking due to excessive temperature rise in the high load state, while reducing a friction caused by an oil viscosity in the low load state.

It is assumable, in a control of an internal combustion engine, to enable to reduce a fuel consumption rate by causing combustion in the internal combustion engine at a leaner air-fuel ratio than the stoichiometric air-fuel ratio or by performing so-called exhaust gas recirculation.

Herein, a ratio obtained by dividing a mass flow amount of gas supplied to the internal combustion engine by a mass flow amount of fuel supplied to the internal combustion engine is defined as a “gas ratio”. The above-mentioned controls may be a kind of controls for maintaining the gas ratio at a large value. It is noted that, the above-mentioned “gas” is air supplied from an intake pipe to a cylinder of the internal combustion engine. In a case where the vehicle has an exhaust gas recirculation mechanism, exhaust gas to be recirculated is added to the air.

When the gas ratio is large due to a lean air-fuel ratio or the like, the flow amount of air supplied to the internal combustion engine increases as the output of the internal combustion engine decreases. In this way, a flow path resistance exerted on air in the intake pipe is reduced, and therefore, so-called pumping loss is reduced. As a result, the fuel consumption rate is reduced. Further, when the gas ratio is increased by increasing the ratio of the recirculated exhaust gas, an amount of carbon dioxide supplied to the internal combustion engine is increased, and a specific heat of combustion gas is increased. As a result, a combustion temperature is lowered, and an amount of heat that is dissipated from the combustion gas to the wall of the internal combustion engine is reduced, and therefore, the fuel consumption rate is also reduced.

However, when the gas ratio is increased excessively, issues such as instability of combustion in the internal combustion engine may occur. Therefore, it is assumable to set the gas ratio as large as possible within a range not to exceed a predetermined target value.

According to an example of the present disclosure, a control is performed to change the target value of the ratio of exhaust gas recirculated according to a temperature of cooling water.

In this case, it is conceivable to set the target value of the gas ratio based on the temperature of the cooling water passing through the internal combustion engine. However, according to an experiment conducted by the present inventors, it has been found that the target value of the gas ratio that is set based only on the temperature of the cooling water does not necessarily match an ideal target value.

In other words, even when the gas ratio is matched to the target value that is set based only on the temperature of the cooling water, there is actually room for further increasing the gas ratio, or conversely, the gas ratio may become excessively large. In particular, as in the control of the above example, in a case where the temperature of the cooling water is changed according to the load of the internal combustion engine, a deviation between the target value of the gas ratio that is set based on the temperature of the cooling water and the ideal target value tends to be large in a period immediately after changing the temperature of the cooling water. As described above, in the conventional control device, there is room for further improvement in terms of appropriately controlling the gas ratio.

A control device according to the present disclosure is a control device for an internal combustion engine and includes a wall temperature acquisition unit configured to acquire a wall temperature of the internal combustion engine; a wall temperature adjustment unit configured to adjust the wall temperature; and a ratio adjustment unit configured to adjust a gas ratio, which is a ratio acquired by dividing a mass flow amount of gas supplied to the internal combustion engine by a mass flow amount of fuel supplied to the internal combustion engine. The wall temperature adjustment unit is configured to perform a low wall temperature control to maintain the wall temperature at a low temperature when the internal combustion engine is operated at a high load and a high wall temperature control to maintain the wall temperature at a high temperature when the internal combustion engine is operated at a low load. The ratio adjustment unit is configured to adjust the gas ratio based on the wall temperature acquired by the wall temperature acquisition unit, when switching between the low wall temperature control and the high wall temperature control is performed.

In the control device having this configuration, the wall temperature adjustment unit controls to switch between the low wall temperature control and the high wall temperature control according to the load of the internal combustion engine. This control enables to restrict occurrence of knocking in the high load state, while reducing a friction caused by an oil viscosity in the low load state.

Further, in the above configuration, the ratio adjustment unit is configured to adjust the gas ratio based on the wall temperature acquired by the wall temperature acquisition unit, when switching between the low wall temperature control and the high wall temperature control is performed. As a result of experiments conducted by the present inventors and the like, a knowledge has been achieved that an ideal gas ratio value changes not according to the temperature of the cooling water but according to, strictly, the wall temperature of the internal combustion engine. Therefore, by adjusting the gas ratio based on the wall temperature as described above, the gas ratio can be increased as much as possible within a range in which the gas ratio does not exceed the ideal target value. The value of the gas ratio adjusted in this way does not deviate from the ideal value even immediately after the switching between the low wall temperature control and the high wall temperature control is performed. This configuration enables to appropriately control the gas ratio in the internal combustion engine.

The present disclosure may enable to provide a control device configured to appropriately control the gas ratio for an internal combustion engine.

Hereinafter, the present embodiments will be described with reference to the attached drawings. In order to facilitate the ease of understanding, the same reference numerals are attached to the same constituent elements in each drawing where possible, and redundant explanations are omitted.

A first embodiment will be described. A control device 100 according to the present embodiment is a device mounted on a vehicle 10 and is configured as a device for controlling an internal combustion engine 200 of the vehicle 10. Prior to the description of the control device 100, the configuration of the vehicle 10 will be described first.

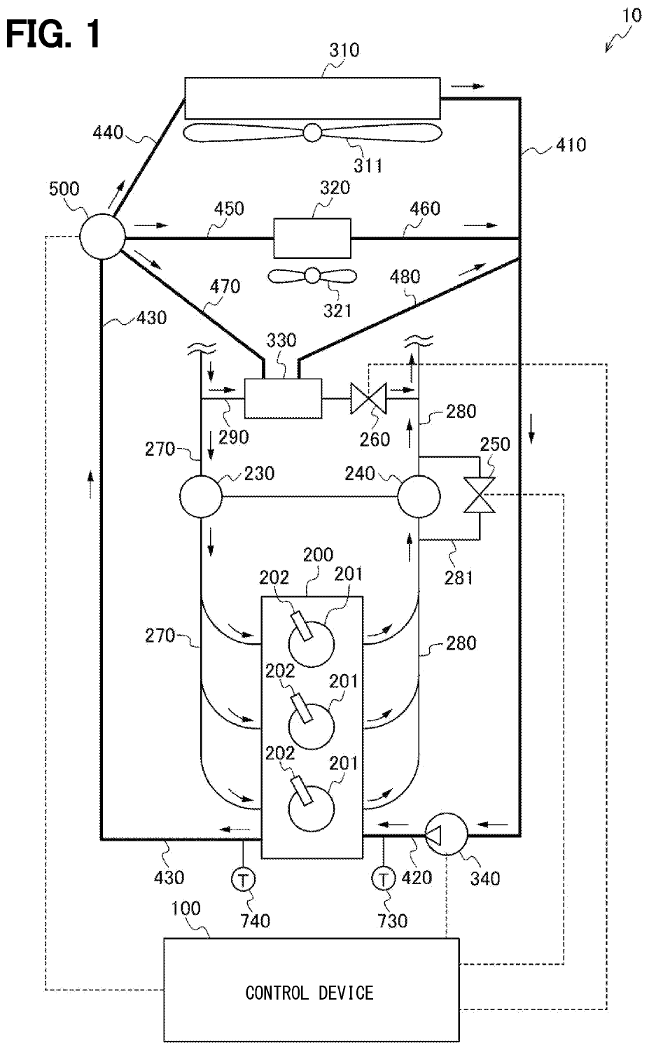

FIG. 1 schematically shows the configuration of the vehicle 10 including the control device 100. In the drawing, only a part of the vehicle 10 related to the control performed by the control device 100 is shown, and the other parts such as wheels and the like are not shown.

First, the configuration of the internal combustion engine 200 and its surroundings will be described mainly with reference to FIG. 1. The internal combustion engine 200 is a device that generates a driving force of the vehicle 10 by burning fuel. The internal combustion engine 200 has three cylinders 201, and fuel is burned in each of the cylinders 201. Each of the cylinders 201 is provided with an injector 202 for injecting and sharing fuel. An opening/closing operation of the injector 202 is controlled by the control device 100. With this configuration, a mass flow amount of the fuel supplied to each cylinder 201 is adjusted.

An intake pipe 270 and an exhaust pipe 280 are connected to the internal combustion engine 200. An intake pipe 20 is a pipe for supplying air to the internal combustion engine 200. A portion of the intake pipe 270 on the side of the internal combustion engine 200 is branched into three pipes, and the branched pipes are connected to the cylinders 201, respectively.

The exhaust pipe 280 is a pipe for discharging exhaust gas generated by combustion in each cylinder 201 to the outside of the vehicle 10. A portion of the exhaust pipe 280 on the side of the internal combustion engine 200 is branched into three pipes, and the branched pipes are connected to the cylinders 201, respectively.

A compressor 230 is provided in a midway portion of the intake pipe 270, and a turbine 240 is provided in a midway portion of the exhaust pipe 280. The compressor 230 and the turbine 240 constitute a so-called “supercharger”.

The turbine 240 rotates in response to a flow of exhaust gas passing through the exhaust pipe 280, thereby operating the compressor 230. The compressor 230 operates by a force received from the turbine 240, compresses air in the intake pipe 270, and sends the air out to the internal combustion engine 200. In this way, the substantial displacement of the internal combustion engine 200 can be increased.

The exhaust pipe 280 is provided with a bypass pipe 281 for passing the exhaust gas by bypassing the turbine 240. Further, a wastegate valve 250 is provided in a midway portion of the bypass pipe 281. The wastegate valve 250 is a valve for adjusting the flow amount of the exhaust gas passing through the bypass pipe 281 by changing an opening degree thereof. The operation of the bypass pipe 281 is controlled by the control device 100.

An EGR pipe 290 is provided between the intake pipe 270 and the exhaust pipe 280 to connect therebetween. One end of the EGR pipe 290 is connected to a portion of the intake pipe 270 that is upstream of the compressor 230. The other end of the EGR pipe 290 is connected to a portion of the exhaust pipe 280 that is downstream of the turbine 240. The EGR pipe 290 is a pipe for performing so-called exhaust gas recirculation. A part of the exhaust gas passing through the exhaust pipe 280 flows into the intake pipe 270 through the EGR pipe 290 and is supplied to each cylinder of the internal combustion engine 200 again. This configuration enables to reduce a fuel consumption rate of the internal combustion engine 200.

An EGR valve 260 and an EGR cooler 330 are provided in a midway portion of the EGR pipe 290. The EGR valve 260 is a valve for adjusting a flow amount of the exhaust gas passing through the EGR pipe 290. With this configuration, the ratio of the exhaust gas recirculated to the intake pipe 270 is adjusted. The operation of the EGR valve 260 is controlled by the control device 100.

The EGR cooler 330 is a heat exchanger for cooling high-temperature exhaust gas passing through the EGR pipe 290 by performing heat exchange with cooling water. The EGR cooler 330 is configured to cool and shrink the exhaust gas recirculated to the internal combustion engine 200 to increase its density.

The circulation path of the cooling water will be described with reference mainly to FIG. 1. Cooling water is supplied to the internal combustion engine 200, whereby the internal combustion engine 200 is kept at an appropriate temperature. A pipe 420 is a pipe for supplying cooling water to the internal combustion engine 200. A pipe 430 is a pipe for discharging the cooling water from the internal combustion engine 200 to the outside.

A water pump 340 is provided at an end of the pipe 420 on the side opposite to the internal combustion engine 200. Further, a pipe 410 is connected to the water pump 340. The water pump 340 is a pump for feeding cooling water from the pipe 410 to the pipe 420. The water pump 340 of the present embodiment is configured to operate by receiving a driving force from the internal combustion engine 200. Therefore, as the rotation speed of the internal combustion engine 200 increases, the flow amount of the cooling water supplied from the water pump 340 to the internal combustion engine 200 increases.

The other end of the pipe 410 connected to the water pump 340 is connected to a radiator 310. The radiator 310 is a heat exchanger for lowering the temperature of the cooling water by performing heat exchange with air. The radiator 310 is arranged in a front side portion of the vehicle 10. Air flowing into the radiator 310 is supplied from a front grill (not shown) provided in the vehicle 10, and heat exchange is performed between the air and the cooling water. A fan 311 for promoting the air flow is provided in the vicinity of the radiator 310.

In FIG. 1, both the intake pipe 270 and the exhaust pipe 280 are drawn so as to extend toward the radiator 310 on the front side of the vehicle 10. However, FIG. 1 schematically shows the connection destination and the like of the pipes. The extending direction and the like of the pipes in the drawing are different from that in the actual configuration.

The pipe 430 extending from the internal combustion engine 200 is connected to the radiator 310 via a flow control valve 500 and a pipe 440. With this configuration, the cooling water fed by the water pump 340 circulates between the internal combustion engine 200 and the radiator 310 along a path that passes through the pipe 420, the pipe 430, the flow control valve 500, the pipe 440, and the pipe 410 in this order. The configuration of the flow control valve 500 will be described later.

The pipe 420 is provided with an inlet water temperature sensor 730. The inlet water temperature sensor 730 is a temperature sensor for measuring the temperature of the cooling water passing through the pipe 420, that is, the temperature of the cooling water at the inlet of the internal combustion engine 200. The temperature of the cooling water measured by the inlet water temperature sensor 730 is transmitted to the control device 100.

Similarly, the pipe 430 is provided with an outlet water temperature sensor 740. The outlet water temperature sensor 740 is a temperature sensor for measuring the temperature of the cooling water passing through the pipe 430, that is, the temperature of the cooling water at the outlet of the internal combustion engine 200. The temperature of the cooling water measured by the outlet water temperature sensor 740 is transmitted to the control device 100.

The vehicle 10 is provided with a heater core 320 and the EGR cooler 330 as devices that utilize the circulating cooling water.

The heater core 320 is a heat exchanger for raising the temperature of air by exchanging heat between high-temperature cooling water and air. The heater core 320 is provided as a part of the air conditioner mounted on the vehicle 10. The air heated by passing through the heater core 320 is supplied to the passenger compartment of the vehicle 10 as conditioned air for heating. A fan 321 for sending the air toward the passenger compartment is provided in the vicinity of the heater core 320.

The heater core 320 and the flow control valve 500 are connected by a pipe 450. Further, the heater core 320 and the pipe 410 are connected by a pipe 460. When the cooling water is supplied from the flow control valve 500 to the pipe 450, the cooling water is subjected to the above heat exchange through the heater core 320, and then passes through the pipe 460 and joins with cooling water that flows through the pipe 410.

As described above, the EGR cooler 330 is a heat exchanger for cooling high-temperature exhaust gas passing through the EGR pipe 290 by performing heat exchange with cooling water. The heater core 320 and the flow control valve 500 are connected by the pipe 450. Further, the EGR cooler 330 and the pipe 410 are connected by a pipe 480. When the cooling water is supplied from the flow control valve 500 to a pipe 470, the cooling water is subjected to the above-described heat exchange through the EGR cooler 330, then passes through the pipe 480 and joins with cooling water that flows through the pipe 410.

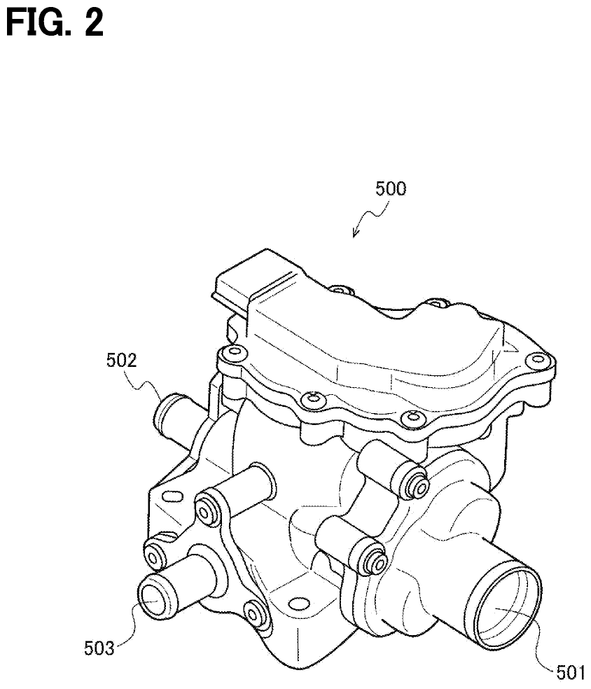

The configuration of the flow control valve 500 will be described. FIG. 2 as a perspective view shows the appearance of the flow control valve 500. As shown in the drawing, the flow control valve 500 is formed with three outlets 501, 502, and 503. All of these are outlets for cooling water from the flow control valve 500. The outlet 501 is a portion to which the pipe 470 is connected. The outlet 502 is a portion to which the pipe 450 is connected. The outlet 503 is a portion to which the pipe 440 is connected.

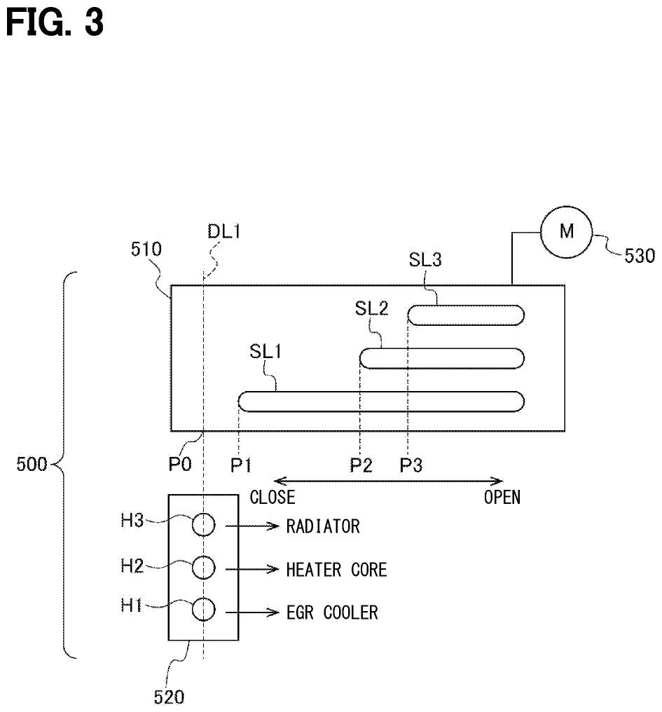

FIG. 3 schematically shows the internal configuration of the flow control valve 500. In the drawing, the object with the reference numeral 510 shows the side surface of the cylindrical valve body that is housed inside the flow control valve 500 and is unfolded. The circumferential direction of the side surface of the valve body is drawn so as to be the left-right direction in FIG. 3. The valve body is also referred to as “valve body 510” below. Further, in the drawing, the object with the reference numeral 520 illustrates an inner peripheral surface of a portion of the flow control valve 500 that accommodates the valve body 510. The inner peripheral surface is also referred to as “inner peripheral surface 520” below.

A space (not shown) is formed inside the valve body 510. The cooling water supplied to the flow control valve 500 through the pipe 430 first flows into the space inside the valve body 510. Three slit-shaped openings SL1, SL2, and SL3 are formed in the side surface of the valve body 510 along the axial direction of the valve body 510. All of these are formed so as to extend linearly along the circumferential direction of the side surface of the valve body 510, that is, the left-right direction in FIG. 3. The cooling water that has flowed into the space inside the valve body 510 flows out from the inside of the valve body 510 to the outside through the slit-shaped openings SL1, SL2, and/or SL3.

Three through holes H1, H2, and H3 are formed in the inner peripheral surface 520.

The through hole H1 is formed at a position at the same height as the opening SL1 in the central axis direction of the valve body 510. The through hole H1 is connected to the outlet 501. Therefore, when the through hole H1 overlaps the opening SL1, the cooling water passes through the opening SL1, the through hole H1, and the outlet 501, and then is supplied to the EGR cooler 330 through the pipe 470.

The through hole H2 is formed at a position at the same height as the opening SL2 in the axial direction of the valve body 510. The through hole H2 is connected to the outlet 502. Therefore, when the through hole H2 overlaps the opening SL2, the cooling water passes through the opening SL2, the through hole H2, and the outlet 502, and then is supplied to the heater core 320 through the pipe 450.

The through hole H3 is formed at a position at the same height as the opening SL3 in the axial direction of the valve body 510. The through hole H3 is connected to the outlet 503. Therefore, when the through hole H3 overlaps the opening SL3, the cooling water passes through the opening SL3, the through hole H3, and the outlet 503, and then is supplied to the radiator 310 through the pipe 440.

The flow control valve 500 is provided with a motor 530. The flow control valve 500 is capable of rotating the valve body 510 about its central axis by the driving force of the motor 530. The rotation angle of the valve body 510 is also hereinafter referred to as a “position” of the valve body 510. In FIG. 3, a dotted line DL1 is shown along the portion of the valve body 510 in which the openings SL1, SL2, and SL3 are formed. When the position of the valve body 510 is changed by the driving force of the motor 530, the dotted line DL1 moves in the left-right direction in FIG. 3 on the side surface of the valve body 510.

In the state shown in FIG. 3, the through hole H1 does not overlap the opening SL1, the through hole H2 does not overlap the opening SL2, and the through hole H3 does not overlap the opening SL3. Therefore, the cooling water is not discharged from any of the outlets 501, 502, and 503. The position of the dotted line DL1 at this time is shown as P0 in FIG. 3.

When the valve body 510 rotates from the state of FIG. 3 and reaches P1 where the dotted line DL1 overlaps the opening SL1, the through hole H1 overlaps the opening SL1. Therefore, the cooling water starts to be supplied from the outlet 501 toward the EGR cooler 330. The flow amount of the cooling water flowing out from the outlet 501 changes depending on how the through hole H1 and the opening SL1 overlap. That is, the opening ratio of the outlet 501 changes. When the entire through hole H1 overlaps the opening SL1, the opening ratio of the outlet 501 becomes 100%.

After that, when the valve body 510 further rotates, and the dotted line DL1 reaches P2, which is a position where the dotted line DL1 overlaps the opening SL2, the through hole H2 is in a state of overlapping the opening SL2. Therefore, the cooling water also starts to be supplied from the outlet 502 toward the heater core 320. The flow amount of the cooling water flowing out from the outlet 502 changes depending on how the through hole H2 and the opening SL2 overlap. That is, the opening ratio of the outlet 502 changes. When the entire through hole H2 overlaps the opening SL2, the opening ratio of the outlet 502 becomes 100%.

After that, when the valve body 510 further rotates, and the dotted line DL1 reaches P3, which is a position where the dotted line DL1 overlaps the opening SL3, the through hole H3 is in a state of overlapping the opening SL3. Therefore, the cooling water also starts to be supplied from the outlet 503 toward the radiator 310. The flow amount of the cooling water flowing out from the outlet 503 changes depending on how the through hole H3 and the opening SL3 overlap. That is, the opening ratio of the outlet 503 changes. When the entire through hole H3 overlaps the opening SL3, the opening ratio of the outlet 503 becomes 100%.

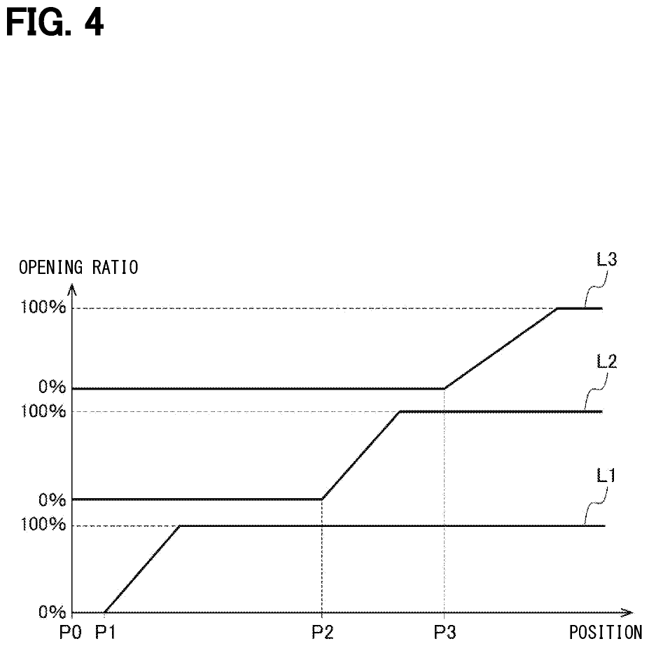

FIG. 4 shows a relationship between the position of the valve body 510, specifically the position of the dotted line DL1 in FIG. 3, and each of the aperture ratios of the outlets 501, 502, and 503. The line L1 shows the opening ratio of the outlet 501, the line L2 shows the opening ratio of the outlet 502, and the line L3 shows the opening ratio of the outlet 503. As shown in FIG. 4, when the position of the valve body 510 changes from P0 to P3, the outlet 501 is first in the open state, then the outlet 502 is in the open state, and finally the outlet 503 is in the open state.

The operation of the motor 530 is controlled by the control device 100. The control device 100 is configured to adjust the opening ratios of the outlets 501, 502, and 503 by adjusting the position of the valve body 510 by controlling the motor 530. As a result, the flow amount of the cooling water supplied to each of the radiator 310, the heater core 320, and the EGR cooler 330 can be adjusted.

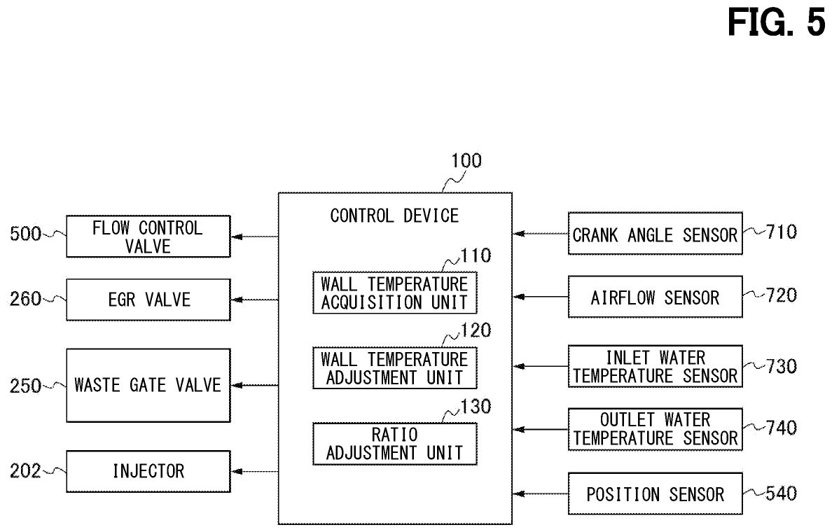

The configuration of the control device 100 will be described with reference to FIG. 5. The control device 100 is a device for controlling the internal combustion engine 200 as described above. The control device 100 is a computer system including a CPU, ROM, RAM, and the like, and is used as a so-called ECU. The control device 100 includes a wall temperature acquisition unit 110, a wall temperature adjustment unit 120, and a ratio adjustment unit 130 as functional control blocks.

The wall temperature acquisition unit 110 is a portion that executes a processing to acquire the wall temperature of the internal combustion engine 200. The “wall temperature” referred to here is a temperature of components constituting the cylinder of the internal combustion engine 200, and in particular, the temperature in the vicinity of a portion where the combustion chamber is formed. The wall temperature acquisition unit 110 according to the present embodiment computes and acquires the wall temperature based on the flow amount and temperature of the cooling water passing through the internal combustion engine 200, and a specific acquisition method thereof will be described later.

The wall temperature adjustment unit 120 is a portion that performs the above-mentioned processing for adjusting the wall temperature. The wall temperature adjustment unit 120 according to the present embodiment is configured to change the flow amount and the temperature of the cooling water supplied to the internal combustion engine 200 by controlling the operation of the flow control valve 500, thereby adjusting the wall temperature.

The ratio adjustment unit 130 is a portion that performs processing to adjust the gas ratio. The “gas ratio” is a ratio obtained by dividing the mass flow amount of the gas supplied to the internal combustion engine 200 by the mass flow amount of the fuel supplied to the internal combustion engine 200. The above-mentioned “gas” is air supplied from the intake pipe 270 to each cylinder 201 of the internal combustion engine 200. When the vehicle 10 has the exhaust gas recirculation mechanism as in the present embodiment, the above-mentioned “gas” represents a mixture of the exhaust gas recirculated from the EGR pipe 290 to the intake pipe 270 and the above-described air.

The ratio adjustment unit 130 sets the target value of the gas ratio and further controls the ratio of the exhaust gas recirculated to the intake pipe 270 and controls the air-fuel ratio at the time of combustion in the internal combustion engine 200, such that the gas ratio approaches the target value. The ratio of the exhaust gas recirculated to the intake pipe 270 can be adjusted by the EGR valve 260. Further, the air-fuel ratio at the time of combustion in the internal combustion engine 200 can be adjusted by, for example, the wastegate valve 250.

The ratio adjustment unit 130 sets the target value for the gas ratio to a value as large as possible within a range in which combustion in the internal combustion engine 200 does not become unstable. This configuration enables to reduce a fuel consumption rate of the internal combustion engine 200. Details of specific processing executed for adjusting the gas ratio will be described later.

As described above, the control device 100 controls the operation of respective devices such as the flow control valve 500 mounted on the vehicle 10. FIG. 5 shows a flow control valve 500, the EGR valve 260, the wastegate valve 250, and the injector 202 as devices to be controlled by the control device 100.

Further, the measured value is input to the control device 100 from the sensors provided in respective parts of the vehicle 10. In FIG. 5, as such sensors, a crank angle sensor 710, an air flow sensor 720, the inlet water temperature sensor 730, the outlet water temperature sensor 740, and a position sensor 540 are shown.

The crank angle sensor 710 is a sensor for measuring the rotation angle of a crankshaft (not shown) included in the internal combustion engine 200. The control device 100 is configured to acquire the number of rotations of the crankshaft per unit time based on the change in the rotation angle input from the crank angle sensor 710. The number of rotations is also hereinafter referred to as “the number of rotation of the internal combustion engine 200”.

The air flow sensor 720 is a sensor for measuring the mass flow amount of air passing through the intake pipe 270. The control device 100 is configured to acquire the magnitude of the load of the internal combustion engine 200 based on the mass flow amount of air input from the air flow sensor 720.

As already described with reference to FIG. 1, the inlet water temperature sensor 730 is a temperature sensor for measuring the temperature of the cooling water at the inlet of the internal combustion engine 200. Further, the outlet water temperature sensor 740 is a temperature sensor for measuring the temperature of the cooling water at the outlet of the internal combustion engine 200.

The position sensor 540 is a sensor built in the flow control valve 500 and is a sensor for detecting the position of the valve body 510 included in the flow control valve 500. The control device 100 is configured to acquire opening ratios of the outlets 501, 502, and 503, respectively, based on the position input from the position sensor 540.

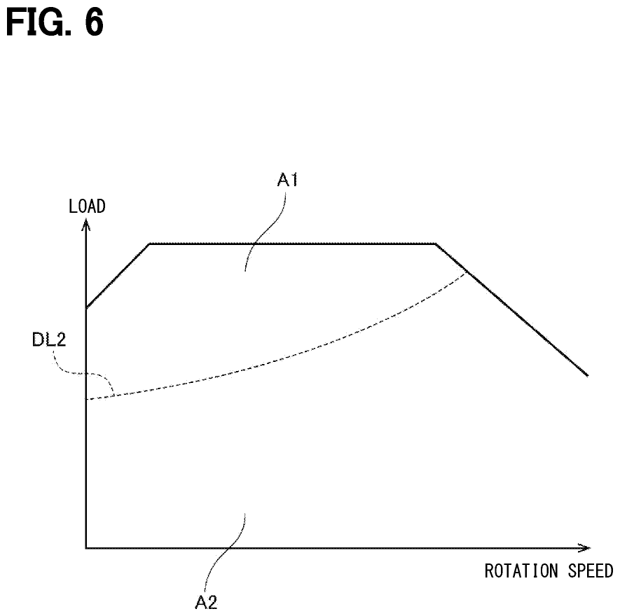

The outline of the control performed by the control device 100 will be described. The horizontal axis of FIG. 6 shows the rotation speed of the internal combustion engine 200. The vertical axis of FIG. 6 shows the load of the internal combustion engine 200, specifically, the flow amount of air passing through the intake pipe 270.

In the present embodiment, when the operating state, which is determined by the rotation speed of the internal combustion engine 200 and the flow amount of air, is in the region A1 on the higher load side than the dotted line DL2 in FIG. 6, the wall temperature adjustment unit 120 performs a low wall temperature control. The “low wall temperature control” is a control that maintains the wall temperature at a low temperature.

Further, when the operating state, which is determined by the rotation speed of the internal combustion engine 200 and the flow amount of air, is in the region A2 on the lower load side than the dotted line DL2 in FIG. 6, the wall temperature adjustment unit 120 performs a high wall temperature control. The “high wall temperature control” is a control to maintain the wall temperature at a high temperature.

As described above, the wall temperature adjustment unit 120 according to the present embodiment is configured to perform the low wall temperature control for maintaining the wall temperature at a low temperature when the internal combustion engine 200 is operated at a high load. On the other hand, the wall temperature adjustment unit 120 according to the present embodiment is configured to perform the high wall temperature control for maintaining the wall temperature at a high temperature when the internal combustion engine 200 is operated at a low load.

By performing the high wall temperature control when the load is low, it is possible to reduce the friction associated with the oil viscosity. However, in a case where the high wall temperature control is continued as it is even when the load is high, knocking may occur in the internal combustion engine 200 due to an excessive temperature rise. Therefore, when the load is high, knocking is restricted by switching to the low wall temperature control.

The target value of the wall temperature when the high wall temperature control is performed in the region A2 may be constant or may be changed depending on the operating state. For example, the wall temperature may be adjusted so that the closer to the dotted line DL2, the lower the temperature, and the farther from the dotted line DL2, the higher the temperature. Similarly, the wall temperature when the low wall temperature control is performed in the region A1 may be constant or may be changed depending on the operating state. For example, the wall temperature may be adjusted so that the closer to the dotted line DL2, the higher the temperature, and the farther from the dotted line DL2, the lower the temperature. In any case, the target value of the wall temperature in each of the high wall temperature control and the low wall temperature control may be set for respective operation states corresponding to respective parts in FIG. 6.

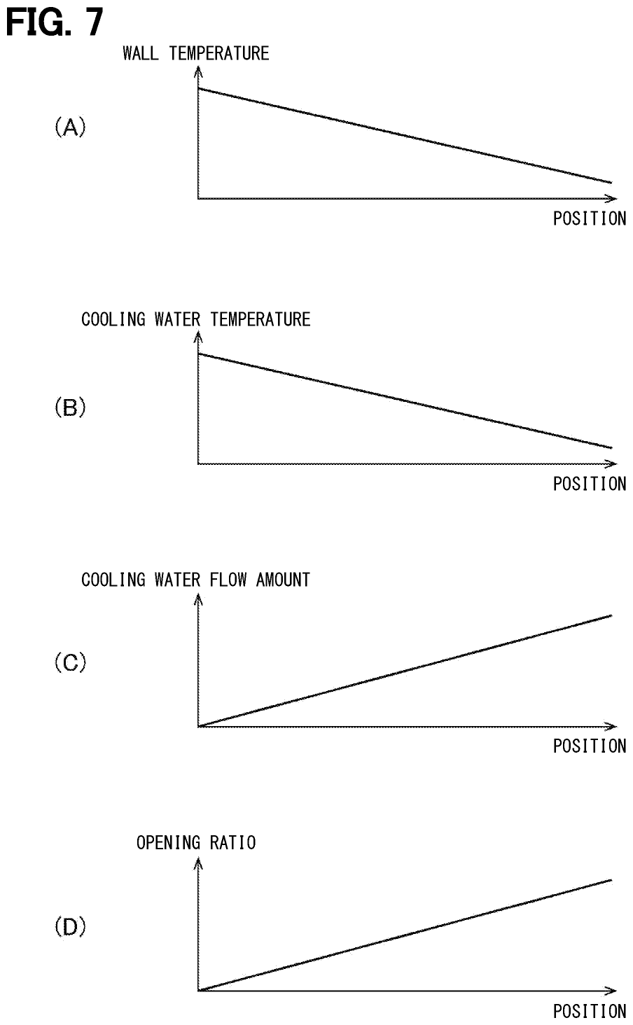

A method of adjusting the wall temperature by the wall temperature adjustment unit 120 will be described with reference to FIG. 7. (A) in FIG. 7 shows a relationship between the position of the valve body 510 included in the flow control valve 500 and the wall temperature. (B) in FIG. 7 shows a relationship between the position of the valve body 510 and the temperature of the cooling water passing through the internal combustion engine 200. (C) in FIG. 7 shows a relationship between the position of the valve body 510 and the flow amount of the cooling water passing through the internal combustion engine 200. (D) in FIG. 7 (D) shows a relationship between the position of the valve body 510 and the opening ratio of the outlet 503 in the flow control valve 500.

When the position of the valve body 510 is changed in the direction in which the opening ratio of the outlet 503 increases, the flow path resistance in the path through which the cooling water circulates decreases, and therefore, the flow amount of the cooling water passing through the internal combustion engine 200 increases. Further, the flow amount of the cooling water passing through the radiator 310 increases, and therefore, the temperature of the cooling water passing through the internal combustion engine 200 decreases. In this way, the flow amount of the cooling water passing through the internal combustion engine 200 increases, and the temperature of the cooling water decreases. Therefore, the wall temperature decreases as the position of the valve body 510 changes. Thus, the wall temperature adjustment unit 120 according to the present embodiment adjusts the wall temperature by changing the position of the valve body 510 and performs the high wall temperature control and the low wall temperature control as described above.

It is noted that, the wall temperature of the internal combustion engine 200 correlates with each of the flow amount and the temperature of the cooling water passing through the internal combustion engine 200. This is because the heat transfer between a solid and a liquid increases as the flow amount of the liquid increases, and increases as the temperature difference between the solid and the liquid increases.

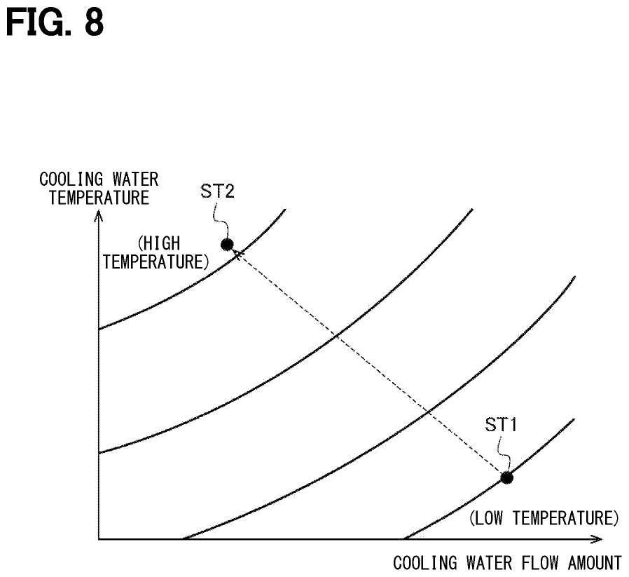

FIG. 8 schematically shows a distribution of the wall temperature determined by the flow amount of the cooling water and the temperature of the cooling water with multiple contour lines. The upper left region in FIG. 8 is a region where the wall temperature is high, and the lower right region is a region where the wall temperature is low. As shown in the drawing, as the flow amount of the cooling water increases, the heat transfer increases as the heat transfer coefficient increases, and the wall temperature decreases. Further, as the temperature of the cooling water becomes higher, the heat transfer becomes smaller as the temperature difference decreases, and the wall temperature becomes higher.

As described above, the wall temperature adjustment unit 120 according to the present embodiment changes both the flow amount and the temperature of the cooling water supplied to the internal combustion engine 200 by controlling the operation of the flow control valve 500, thereby adjusting the wall temperature. Therefore, for example, when the adjustment is made to raise the wall temperature from the state shown in ST1 in FIG. 8, the wall temperature changes along the path shown by the dotted line to shift the state to the state indicated by ST2 in FIG. 8.

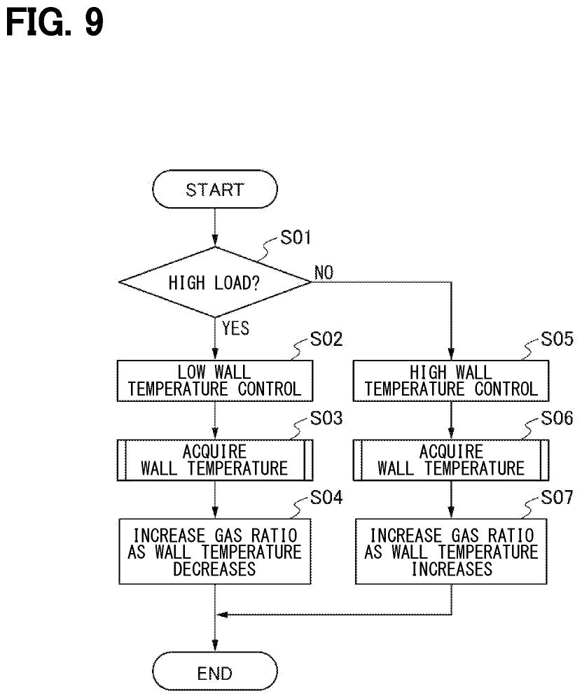

A specific flow of the processing executed by the control device 100 will be described with reference to FIG. 9. The series of the processing shown in FIG. 9 is repeatedly executed by the control device 100 every time a predetermined control cycle elapses.

In the first step S01 of the processing, it is determined whether or not the internal combustion engine 200 is operated at a high load. Specifically, when the operating state, which is determined by the rotation speed of the internal combustion engine 200 and the flow amount of air, is in the region A1 on the high load side of the dotted line DL2 in FIG. 6, it is determined that the internal combustion engine is operated at a high load. It is noted that, the determination in step S01 may be made by a method different from the above. For example, when the magnitude of the load determined by the rotation speed of the internal combustion engine 200 and the flow amount of air is larger than a predetermined value, it may be determined that the internal combustion engine is operated at a high load.

When the internal combustion engine is operated at a high load, the processing proceeds to step S02. In step S02, the wall temperature adjustment unit 120 executes processing of switching to the low wall temperature control. When the low wall temperature control has already been performed at this time, this state is maintained.

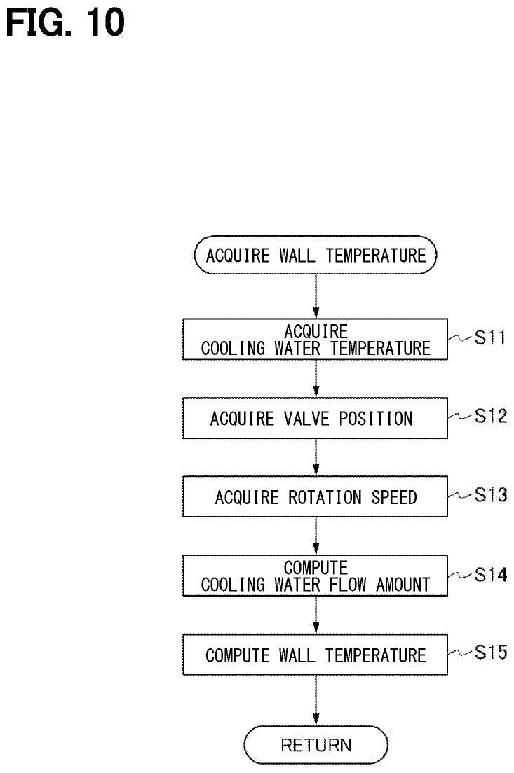

In step S03 following step S02, processing of acquiring the wall temperature is executed by the wall temperature acquisition unit 110. A specific method of the processing will be described with reference to FIG. 10. The flowchart shown in FIG. 10 shows a specific flow of the processing executed in step S03 in FIG. 9.

In the first step S11, processing of acquiring the temperature of the cooling water passing through the internal combustion engine 200 is executed. Here, the temperature measured by the outlet water temperature sensor 740 is acquired.

In step S12 following step S11, the position of the valve body 510 in the flow control valve 500 is acquired. Here, the position measured by the position sensor 540 is acquired.

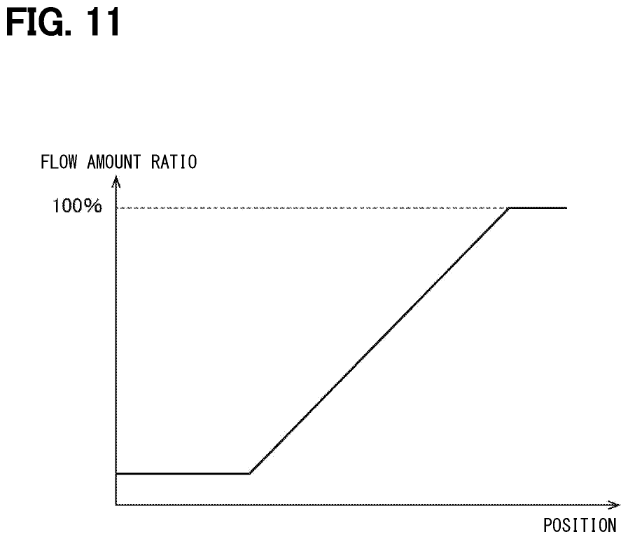

FIG. 11 shows the relationship between the position of the valve body 510 and the flow amount ratio. The “flow amount ratio” is an index indicating the magnitude of the flow amount of the cooling water passing through the internal combustion engine 200. Supposing that the flow amount is set to 100% in a state where the opening ratio of the outlet 503 of the flow control valve 500 is fully open, and the flow amount ratio represents the ratio of the actual flow amount to this flow amount by unit of %. The value of the flow amount ratio is determined according to the position of the valve body 510. The actual flow amount of the cooling water passing through the internal combustion engine 200 is a value obtained by multiplying the flow amount when the opening ratio of the outlet 503 is fully open by the flow amount ratio and by dividing this value by 100.

The correspondence between the position of the valve body 510 and the flow amount ratio as shown in FIG. 11 is created in advance as a map and is stored in the storage device of the control device 100. In step S12 of FIG. 10, the wall temperature acquisition unit 110 computes the flow amount ratio with reference to the acquired position of the valve body 510 and the above map.

The explanation will be continued by returning to FIG. 10. In step S13 following step S12, processing of acquiring the rotation speed of the internal combustion engine 200 is executed. Here, the rotation speed of the internal combustion engine 200 is acquired based on the change in the rotation angle input from the crank angle sensor 710.

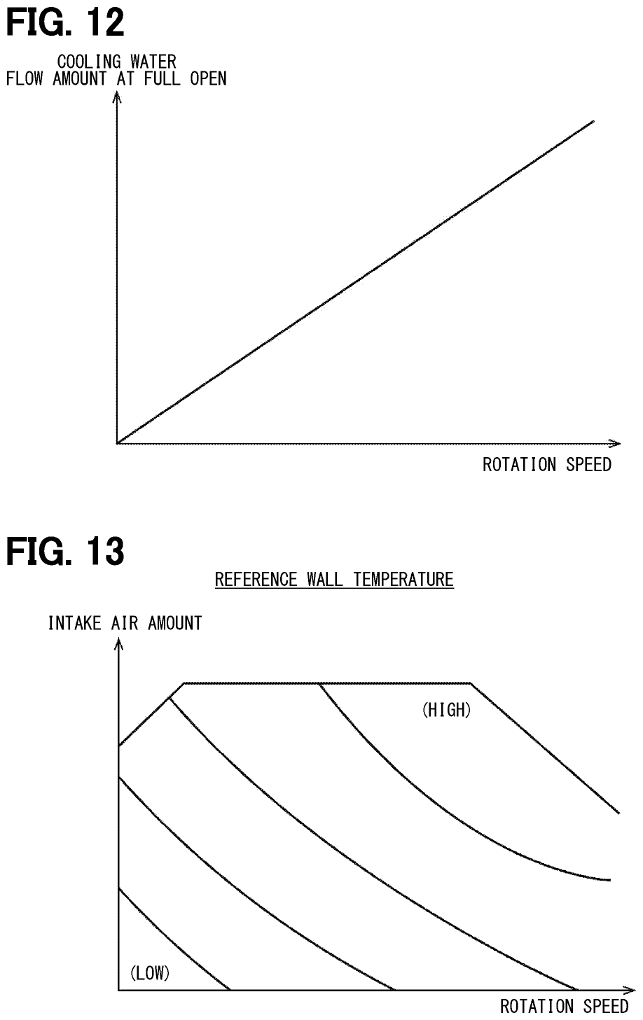

FIG. 12 shows a relationship between the rotation speed of the internal combustion engine 200 and the flow amount of the cooling water when fully opened. The “cooling water flow amount when fully opened” is the flow amount of the cooling water passing through the internal combustion engine 200 when the above-described flow amount ratio is 100%. As shown in the drawing, as the rotation speed of the internal combustion engine 200 increases, the flow amount of the cooling water when fully opened increases.

The correspondence relationship between the rotation speed of the internal combustion engine 200 and the flow amount of the cooling water when fully opened, as shown in FIG. 12, is created in advance as a map and is stored in the storage device of the control device 100. In step S13 of FIG. 10, the wall temperature acquisition unit 110 computes the cooling water flow amount when fully opened with reference to the acquired rotation speed of the internal combustion engine 200 and the above-described map.

The explanation will be continued by returning to FIG. 10. In step S14 following step S13, processing of computing the flow amount of the cooling water passing through the internal combustion engine 200 is executed. Here, the flow amount of the cooling water passing through the internal combustion engine 200 is computed by multiplying the flow amount of the cooling water when fully opened, which is computed in step S13, by the flow amount ratio computed in step S12 and by dividing this value by 100.

In step S15 following step S14, processing of computing the wall temperature is executed. Here, the wall temperature is computed based on the reference wall temperature, the flow amount correction coefficient, and the water temperature correction coefficient.

The “reference wall temperature” in the above description is a reference wall temperature computed based on the rotation speed of the internal combustion engine 200 and the flow amount of air passing through the intake pipe 270. FIG. 13 shows an example of a map used to compute the reference wall temperature. The horizontal axis of FIG. 13 shows the rotation speed of the internal combustion engine 200. The vertical axis of FIG. 13 shows the flow amount of air passing through the intake pipe 270. In FIG. 13, a distribution of the reference wall temperature determined by these two parameters is schematically shown by multiple contour lines. The upper right region in FIG. 13 is a region where the reference wall temperature is high, and the lower left region is a region where the reference wall temperature is low. The map shown in FIG. 13 is created in advance and stored in the storage device of the control device 100. In step S15 of FIG. 10, the wall temperature acquisition unit 110 computes the reference wall temperature with reference to the rotation speed of the internal combustion engine 200, the flow amount of air passing through the intake pipe 270, and the map of FIG. 13. The flow amount of air passing through the intake pipe 270 is measured by the air flow sensor 720 as described above.

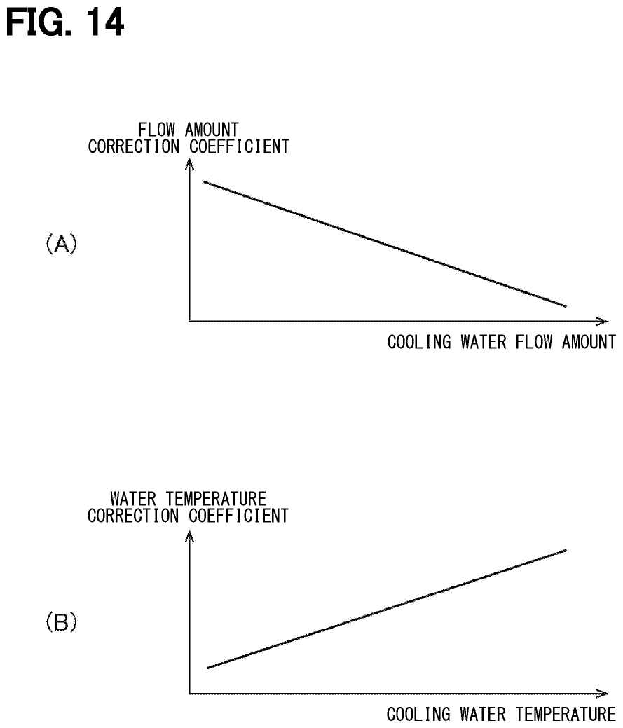

The “flow amount correction coefficient” in the above description is a coefficient that is set according to the flow amount of the cooling water passing through the internal combustion engine 200. As shown in (A) in FIG. 14, the flow amount correction coefficient is set as a smaller value as the flow amount of the cooling water passing through the internal combustion engine 200 increases. The correspondence relationship between the flow amount of the cooling water and the flow amount correction coefficient as shown in (A) in FIG. 14 is created as a map in advance and is stored in the storage device of the control device 100. In step S15 of FIG. 10, the wall temperature acquisition unit 110 computes the flow amount correction coefficient with reference to the flow amount of the cooling water computed in step S14 of FIG. 10 and the above map.

The “water temperature correction coefficient” in the above description is a coefficient that is set according to the temperature of the cooling water passing through the internal combustion engine 200. As shown in (B) in FIG. 14, the water temperature correction coefficient is set as a larger value as the temperature of the cooling water passing through the internal combustion engine 200 increases. The correspondence between the temperature of the cooling water and the water temperature correction coefficient as shown in (B) in FIG. 14 is created in advance as a map and is stored in the storage device of the control device 100. In step S15 of FIG. 10, the wall temperature acquisition unit 110 computes the water temperature correction coefficient with reference to the temperature of the cooling water acquired in step S11 of FIG. 10 and the above map.

In step S15, the wall temperature is computed by multiplying the reference wall temperature by each of the flow amount correction coefficient and the temperature correction coefficient. In this way, the wall temperature acquisition unit 110 according to the present embodiment is configured to acquire the wall temperature based on the flow amount and the temperature of the cooling water passing through the internal combustion engine 200. In such a configuration, it is not necessary to provide a temperature sensor for directly acquiring the wall temperature, so that cost for the component can be suppressed. It is noted that, instead of the above-described embodiment, the internal combustion engine 200 may be provided with a temperature sensor for directly acquiring the wall temperature. In this case, the wall temperature acquisition unit 110 may acquire the wall temperature based on the measured value input from the temperature sensor.

The explanation will be continued by returning to FIG. 9. After the processing of acquiring the wall temperature is executed in step S03, the processing proceeds to step S04. In step S04, processing of adjusting the gas ratio is executed based on the wall temperature acquired in step S03. Specifically, the processing of adjusting is executed so that the target value of the gas ratio becomes larger as the wall temperature becomes lower. The processing is executed by the ratio adjustment unit 130.

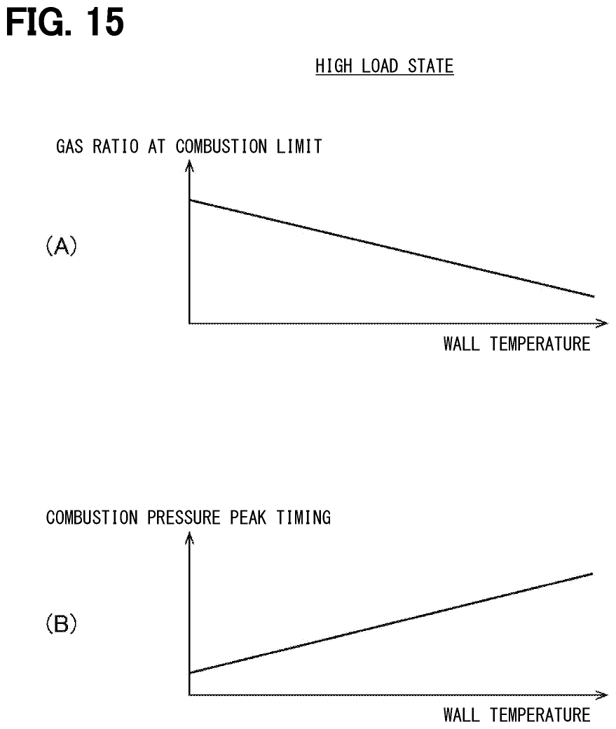

The reason why the target value of the gas ratio is adjusted as described above will be described with reference to FIG. 15. (A) in FIG. 15 shows a relationship between the wall temperature and the gas ratio at the combustion limit when the internal combustion engine 200 is operated at a high load. The “gas ratio at the combustion limit” in the above description is an upper limit in the range of the gas ratio so that combustion in the internal combustion engine 200 is stably performed. In other words, the “gas ratio at the combustion limit” is a value of the gas ratio such that combustion in the internal combustion engine 200 becomes unstable when the gas ratio exceeds the value. In other words, this value is an ideal target value for the gas ratio.

(B) in FIG. 15 shows a relationship between the wall temperature and a combustion pressure peak timing when the internal combustion engine 200 is operated at a high load. The “combustion pressure peak timing” is a timing at which, the pressure value reaches its peak, after the internal combustion engine 200 is ignited by a spark plug (not shown), and the pressure rises due to combustion. As the timing of the ignition becomes earlier, that is, the more the ignition timing is advanced, the combustion pressure peak timing shown by the vertical axis of FIG. 15B is further advanced.

During the high-load operation, in order to restrict knocking due to excessive temperature rise, the ignition timing is delayed as the wall temperature rises, and the temperature of the combustion chamber is lowered. In other words, as the wall temperature becomes lower, the ignition timing is further advanced. Therefore, as shown in (B) in FIG. 15, as the wall temperature decreases, the ignition timing is advanced, and the combustion pressure peak timing is advanced.

When the wall temperature becomes low, and the peak combustion pressure time is advanced, combustion occurs at an early timing closer to the top dead center. In this way, the combustion in the internal combustion engine 200 becomes stable, and there is a lot of room for increasing the gas ratio. Therefore, as shown in (A) in FIG. 15, as the wall temperature becomes lower, the value of the gas ratio at the combustion limit becomes larger.

In consideration of this, in the present embodiment as described above, when the internal combustion engine 200 is operated at a high load, the wall temperature adjustment unit 120 performs the low wall temperature control to lower the wall temperature thereby to stabilize the combustion. In addition, the ratio adjustment unit 130 performs the adjustment so that as the wall temperature becomes lower, the target value of the gas ratio becomes larger. Therefore, the gas ratio is increased as large as possible within the range in which the combustion limit is not exceeded. This configuration enables to reduce a fuel consumption rate in the internal combustion engine 200.

The explanation will be continued by returning to FIG. 9. In step S01, when it is determined that the internal combustion engine 200 is not operated at a high load, the processing proceeds to step S05. In step S05, the wall temperature adjustment unit 120 executes processing of switching to the high wall temperature control. When the high wall temperature control has already been performed at this time, this state is maintained.

In step S06 following step S05, processing of acquiring the wall temperature is executed by the wall temperature acquisition unit 110. The specific method of the processing is the same as the method performed in step S03, and therefore, the description thereof is omitted.

In step S07 following step 06, processing of adjusting the gas ratio is executed based on the wall temperature acquired in step S06. Specifically, the processing of adjusting is executed so that the target value of the gas ratio becomes larger as the wall temperature becomes higher. The processing is executed by the ratio adjustment unit 130.

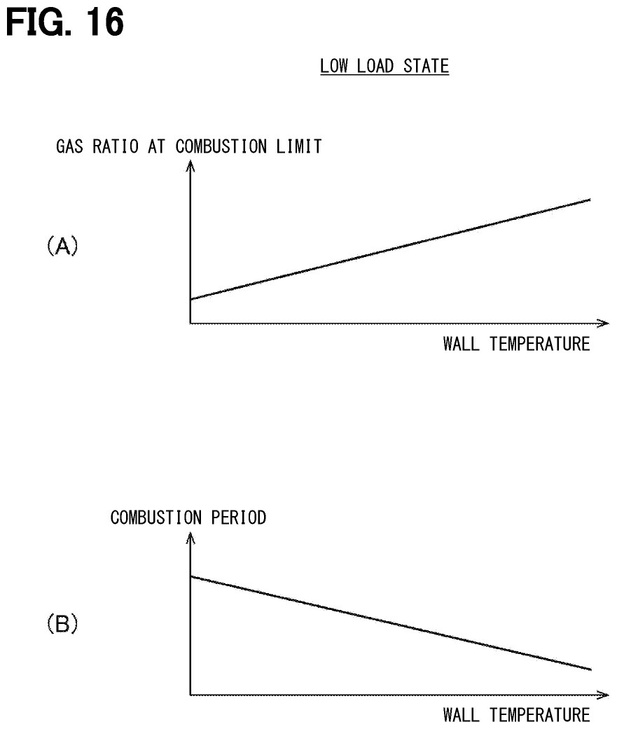

The reason why the target value of the gas ratio is adjusted as described above will be described with reference to FIG. 16. (A) in FIG. 16 shows a relationship between the wall temperature and the gas ratio at the combustion limit when the internal combustion engine 200 is operated at a low load.

(B) in FIG. 16 shows a relationship between the wall temperature and a combustion period when the internal combustion engine 200 is operated at a low load. The “combustion period” is a length of a period from ignition by a spark plug (not shown) to completion of combustion in the internal combustion engine 200.

In a low load operation state, as the wall temperature becomes lower, the heat transfer from the combustion gas to the wall of the internal combustion engine 200 increases. Therefore, the combustion period becomes long, and a variation in combustion in each cylinder 201 becomes large. That is, as the wall temperature becomes lower, the combustion in the internal combustion engine 200 becomes more unstable. In other words, as the wall temperature becomes higher, the combustion in the internal combustion engine 200 becomes more stable. Therefore, as shown in (A) in FIG. 16, as the wall temperature becomes higher, the value of the gas ratio at the combustion limit becomes larger.

In consideration of this, in the present embodiment as described above, when the internal combustion engine 200 is operated at a low load, the wall temperature adjustment unit 120 performs the high wall temperature control to increase the wall temperature thereby to stabilize the combustion. In addition, the ratio adjustment unit 130 performs the adjustment so that as the wall temperature becomes higher, the target value of the gas ratio becomes larger. Therefore, the gas ratio is increased as large as possible within the range in which the combustion limit is not exceeded. This configuration enables to reduce a fuel consumption rate in the internal combustion engine 200.

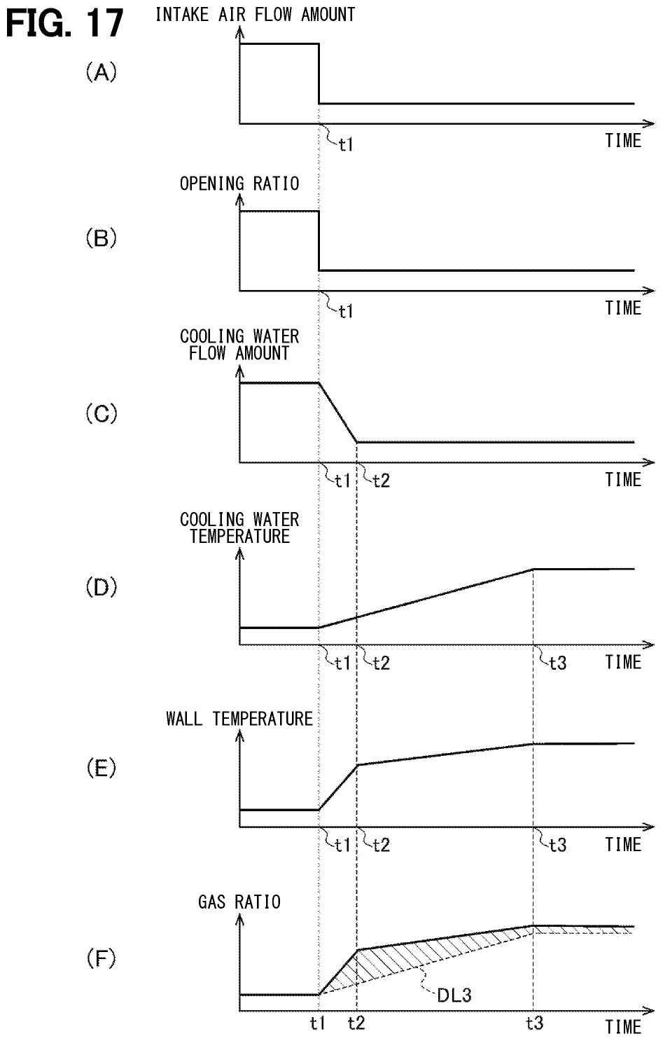

(A) in FIG. 17 shows an example of a time change of the flow amount of air passing through the intake pipe 270. (B) in FIG. 17 shows an example of a time change of the opening ratio of the outlet 503 in the flow control valve 500. (C) in FIG. 17 shows an example of a time change of the flow amount of the cooling water passing through the internal combustion engine 200. (D) in FIG. 17 shows an example of a time change of the temperature of the cooling water passing through the internal combustion engine 200. (E) in FIG. 17 shows an example of a time change of the wall temperature. (F) in FIG. 17 shows an example of a time change of the gas ratio.

In the example of FIG. 17, at the time t1, the load of the internal combustion engine 200 changes from a high load to a low load. Along with this, switching from the low wall temperature control to the high wall temperature control is performed at the same time, and the flow amount of air passing through the intake pipe 270 is reduced.

As the high wall temperature control is started from the time t1, the opening ratio of the outlet 503 in the flow control valve 500 becomes smaller. Therefore, the flow amount of the cooling water decreases from the time t1 to the time t2, and becomes substantially constant after the time t2.

When the opening ratio of the outlet 503 becomes small, the flow amount of the cooling water passing through the radiator 310 decreases, and therefore, the temperature of the cooling water passing through the internal combustion engine 200 increases. However, the temperature rise of the cooling water is not completed in a short period of time, and continues until the time t3 after the time t2.

As described with reference to FIG. 8, the wall temperature correlates with the flow amount and the temperature of the cooling water passing through the internal combustion engine 200. In the example of FIG. 17, in the period from the time t1 to the time t2, the wall temperature rises at a relatively high rate as the flow amount of the cooling water decreases. On the other hand, in the period after the time t2 when the flow amount of the cooling water becomes constant, the wall temperature rises at a relatively slow rate as the temperature of the cooling water rises.

The ratio adjustment unit 130 changes the target value of the gas ratio in response to the increase in the wall temperature as described above. As in the example of FIG. 17, when the control is switched to the high wall temperature control, the ratio adjustment unit 130 performs the adjustment so that as the wall temperature becomes higher, the target value of the gas ratio becomes larger. Therefore, the gas ratio changes as shown by the solid line in (F) in FIG. 17. The value of the gas ratio adjusted in this way is substantially close to the ideal target value, that is, the value of the gas ratio at the combustion limit.

In a control according to an example, the target value of the gas ratio is set based on the temperature of the cooling water, not based on the wall temperature. In (F) in FIG. 17, the change in the gas ratio when the control according to the example is performed is shown by the dotted line DL3. Further, as is clear from the drawing, the value of the gas ratio shown by the dotted line DL3 is smaller than the value of the solid line, that is, the ideal target value. Therefore, in the control according to the example, although there is actually room for further increasing the gas ratio, the gas ratio is suppressed to a small value, and therefore, the fuel consumption rate in the internal combustion engine 200 would become high.

The area of the portion indicated by the hatched line in (F) in FIG. 17 indicates an amount of improvement in the fuel consumption rate due to the control of the present embodiment. The deviation between the ideal gas ratio value shown by the solid line in (F) in FIG. 17 and the gas ratio value that is set based on the water temperature as shown by the dotted line DL3 tens to occur immediately after switching between the low wall temperature control and the high wall temperature. In particular, this deviation tends to be particularly large in a configuration in which the flow amount is rapidly changed by the flow control valve 500.

Although description with reference to a drawing is omitted, in the control according to the example, the target value of the gas ratio that is set based on the temperature of the cooling water becomes a value larger than the ideal target value, contrary to the above configuration. Therefore, combustion in the internal combustion engine 200 may become unstable. To the contrary, according to the control of the present embodiment, the target value of the gas ratio does not exceed the ideal target value. Therefore, the configuration enables to regularly maintain the combustion in the internal combustion engine 200 stable.

As described above, in the present embodiment, when the switching between the low wall temperature control and the high wall temperature control is performed, the ratio adjustment unit 130 is configured to adjust the gas ratio based on the wall temperature acquired by the wall temperature acquisition unit 110. Specifically, when the switch to the low wall temperature control is performed, the ratio adjustment unit 130 performs the adjustment to increase the gas ratio as the wall temperature acquired by the wall temperature acquisition unit 110 becomes lower. In addition, when the switch to the high wall temperature control is performed, the ratio adjustment unit 130 performs the adjustment to increase the gas ratio as the wall temperature acquired by the wall temperature acquisition unit 110 becomes higher. The ratio adjustment unit 130 adjusts the gas ratio as described above, thereby to enable to cause the value of the gas ratio to become closer to the ideal target value. Even immediately after switching between the low wall temperature control and the high wall temperature control, the gas ratio does not deviate from the ideal value. Therefore, the fuel consumption rate in the internal combustion engine 200 can be improved as compared with a conventional configuration.

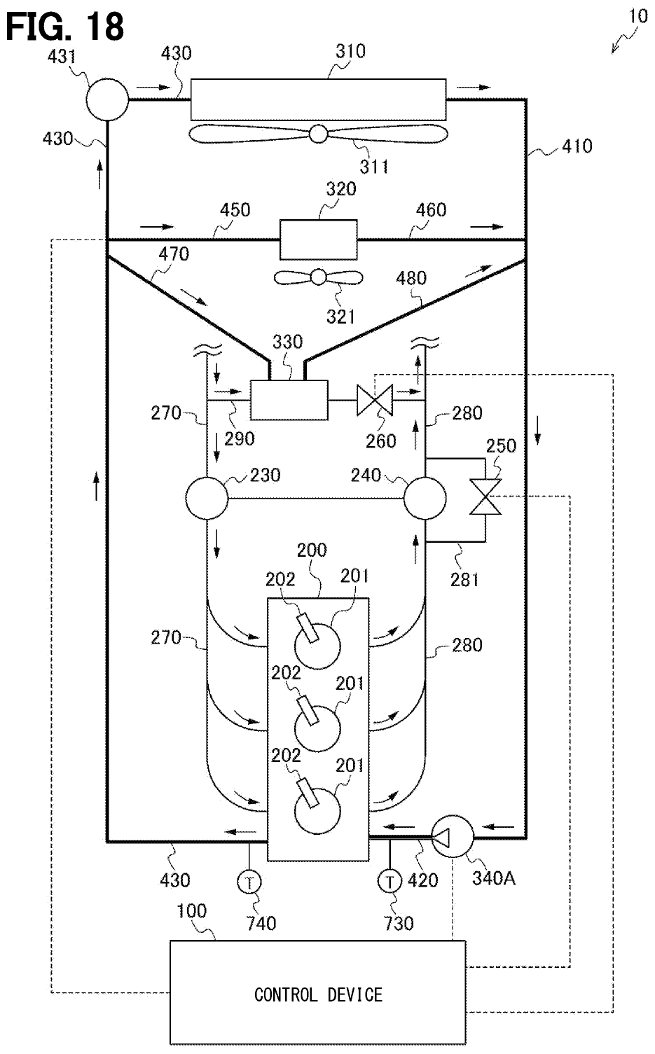

A second embodiment will be described. FIG. 18 schematically shows a configuration of the vehicle 10 according to the second embodiment. Hereinafter, only parts different from the first embodiment will be described, and description of parts common to the first embodiment will be omitted for brevity where appropriate.

In the present embodiment, the flow control valve 500 is not provided, and the pipe 430 extending from the internal combustion engine 200 is directly connected to the radiator 310. Further, the pipe 450 extending from the heater core 320 is connected to the pipe 430, and the pipe 470 extending from the EGR cooler 330 is also connected to the pipe 430.

A thermostat 431 is provided to the pipe 430 at a position that is closer to the radiator 310 than the portion to which the pipe 450 is connected. Thermostat 431 is a valve in which an opening degree is adjusted according to the temperature of the cooling water passing through the pipe 430. Thermostat 431 automatically adjusts the flow amount of the cooling water passing through the radiator 310, and consequently, the temperature of the cooling water discharged from the radiator 310 is regularly maintained constant.

In the present embodiment, a water pump 340A is provided instead of the water pump 340. The water pump 340A does not operate by receiving a driving force from the internal combustion engine 200, but is an electric pump that operates by receiving an electric power supply. Therefore, it is possible to adjust the rotation speed of the water pump 340A and to adjust the flow amount of the cooling water sent out from the water pump 340A, regardless of the rotation speed of the internal combustion engine 200. The rotation speed of the water pump 340A is controlled by the control device 100.

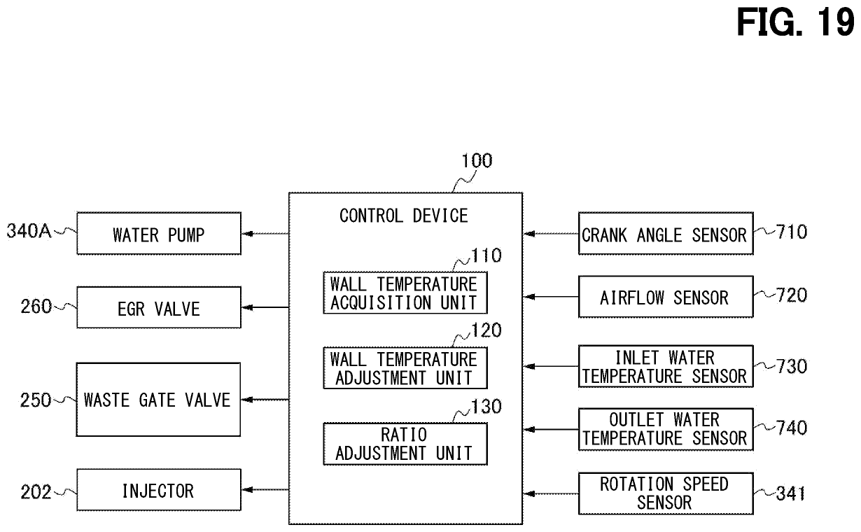

As shown in FIG. 19, the device to be controlled by the control device 100 according to the present embodiment includes the water pump 340A. Further, the sensors provided to respective parts of the vehicle 10 include a rotation speed sensor 341. The rotation speed sensor 341 is a sensor for measuring the rotation speed of the water pump 340A, and is provided on the water pump 340A. The rotation speed measured by the rotation speed sensor 341 is transmitted to the control device 100.

The wall temperature adjustment unit 120 of the present embodiment is configured to change the flow amount of the cooling water passing through the internal combustion engine 200 by changing the rotation speed of the water pump 340A, thereby adjusting the wall temperature of the internal combustion engine 200.

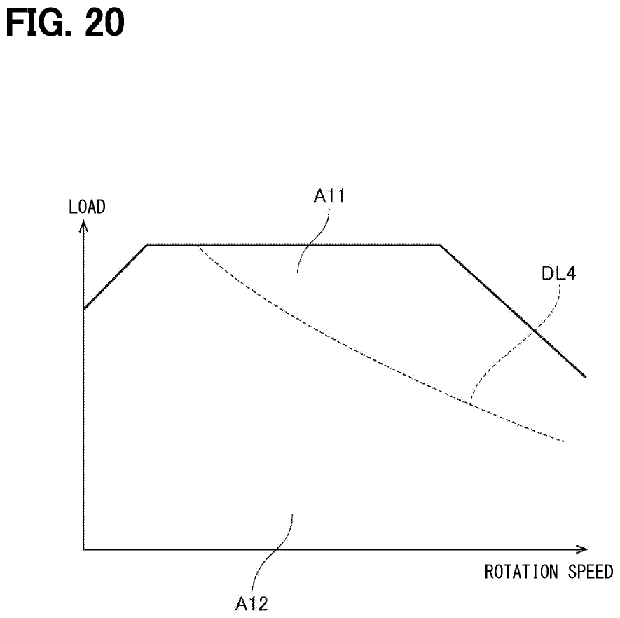

The outline of the control performed by the control device 100 will be described. The horizontal axis of FIG. 20 shows the rotation speed of the internal combustion engine 200. The vertical axis of FIG. 20 shows the load of the internal combustion engine 200, specifically, the flow amount of air passing through the intake pipe 270.

In the present embodiment, when the operating state, which is determined by the rotation speed of the internal combustion engine 200 and the flow amount of air, is in the region A11 on the higher load side than the dotted line DL4 in FIG. 20, the wall temperature adjustment unit 120 performs the low wall temperature control. Further, when the operating state, which is determined by the rotation speed of the internal combustion engine 200 and the flow amount of air, is in the region A12 on the lower load side than the dotted line DL4 in FIG. 20, the wall temperature adjustment unit 120 performs the high wall temperature control.

The target value of the wall temperature when the high wall temperature control is performed in the region A12 may be constant or may be changed depending on the operating state. For example, the wall temperature may be adjusted so that the closer to the dotted line DL4, the lower the temperature, and the farther from the dotted line DL4, the higher the temperature. Similarly, the wall temperature when the low wall temperature control is performed in the region A11 may be constant or may be changed depending on the operating state. For example, the wall temperature may be adjusted so that the closer to the dotted line DL4, the higher the temperature, and the farther from the dotted line DL4, the lower the temperature. In any case, the target value of the wall temperature in each of the high wall temperature control and the low wall temperature control may be set for respective operation states corresponding to respective parts in FIG. 20.

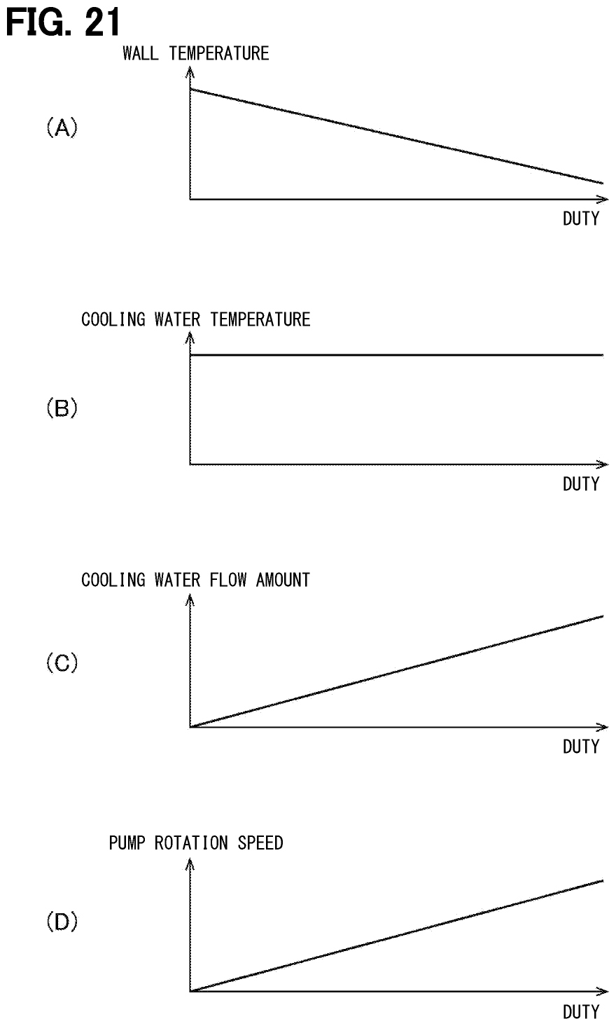

A method of adjusting the wall temperature by the wall temperature adjustment unit 120 will be described with reference to FIG. 21. (A) in FIG. 21 shows a relationship between a duty of a drive signal transmitted from the control device 100 to the water pump 340A and the wall temperature. (B) in FIG. 21 shows a relationship between the duty and the temperature of the cooling water passing through the internal combustion engine 200. (C) in FIG. 21 shows a relationship between the duty and the flow amount of the cooling water passing through the internal combustion engine 200. (D) in FIG. 21 shows a relationship between the duty and the rotation speed of the water pump 340A.

When the duty of the control signal is increased, the rotation speed of the water pump 340A is increased, and therefore, the flow amount of the cooling water passing through the internal combustion engine 200 is increased. On the other hand, in the present embodiment, the temperature of the cooling water passing through the internal combustion engine 200 is regularly maintained constant by the operation of thermostat 431 without being changed by the duty.

As described above, in the present embodiment, only the flow amount of the cooling water passing through the internal combustion engine 200 changes according to the water pump 340A. When the flow amount of the cooling water changes, the heat transfer between the wall of the internal combustion engine 200 and the cooling water changes as the heat transfer coefficient changes. Therefore, as the duty increases and as the rotation speed of the water pump 340A increases, the wall temperature decreases. Thus, the wall temperature adjustment unit 120 according to the present embodiment adjusts the wall temperature by changing the rotation speed of the water pump 340A and performs the high wall temperature control and the low wall temperature control as described above.

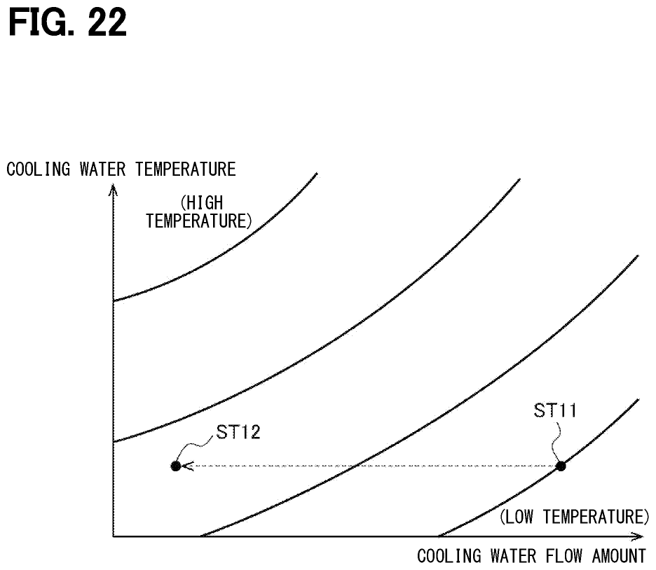

FIG. 22 schematically shows a distribution of the wall temperature determined by the flow amount of the cooling water and the temperature of the cooling water with multiple contour lines. The distribution of wall temperature shown in FIG. 22 is the same as that shown in FIG. 8 as described above.

As described above, the wall temperature adjustment unit 120 according to the present embodiment changes only the flow amount of the cooling water supplied to the internal combustion engine 200 by changing the rotation speed of the water pump 340A, thereby to adjust the wall temperature. Therefore, for example, when the adjustment is made to raise the wall temperature from the state shown in ST11 in FIG. 22, the wall temperature changes along the path shown by the dotted line to shift the state to the state indicated by ST12 in FIG. 22.

Also in this embodiment, the same process as in FIG. 9 is performed by the control device 100. It is noted that, the present embodiment is different from the first embodiment in the content of the processing performed in step S03 and step S06 of FIG. 9, that is, the content of the processing performed to acquire the wall temperature.

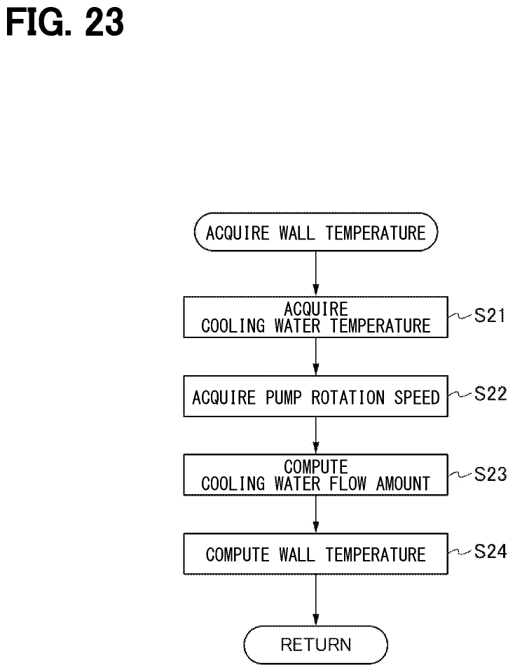

A specific method of processing performed to acquire the wall temperature will be described with reference to FIG. 23. The series of the processing shown in FIG. 23 is executed in place of the series of the processing shown in FIG. 10.

In the first step S21, processing of acquiring the temperature of the cooling water passing through the internal combustion engine 200 is executed. Here, the temperature measured by the outlet water temperature sensor 740 is acquired.

In step S22 following step S21, processing of acquiring the rotation speed of the water pump 340A is performed. Here, the rotation speed measured by the rotation speed sensor 341 is acquired.

In step S23 following step S22, processing of computing the flow amount of the cooling water passing through the internal combustion engine 200 is executed. Here, the flow amount of the cooling water passing through the internal combustion engine 200 is computed based on the rotation speed of the water pump 340A acquired in step S22.

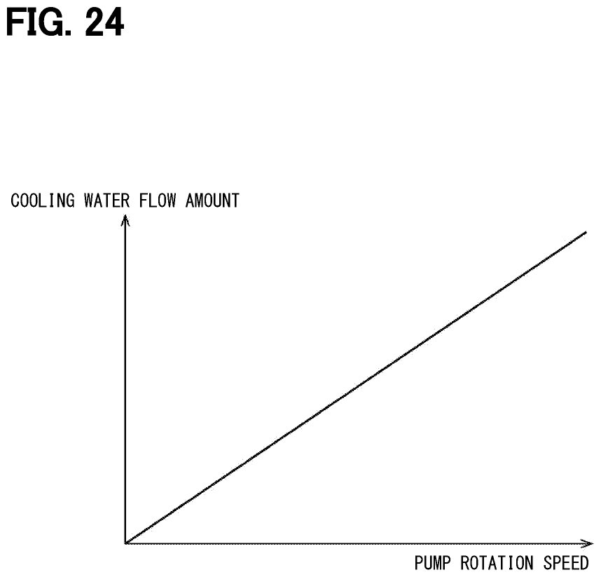

FIG. 24 shows an example of a map used to compute the flow amount of the cooling water. The horizontal axis of FIG. 24 shows the rotation speed of the water pump 340A. The vertical axis of FIG. 24 shows the flow amount of the cooling water passing through the internal combustion engine 200. As shown in FIG. 24, as the rotation speed of the water pump 340A increases, the flow amount of the cooling water passing through the internal combustion engine 200 increases. The map shown in FIG. 24 is created in advance and stored in the storage device of the control device 100. In step S23 of FIG. 24, the wall temperature acquisition unit 110 computes the flow amount of the cooling water passing through the internal combustion engine 200 with reference to the rotation speed of the water pump 340A and the map of FIG. 24.

The explanation will be continued by returning to FIG. 23. In step S24 following step S23, processing of computing the wall temperature is executed. Here, the reference wall temperature, the flow amount correction coefficient, and the water temperature correction coefficient described in the first embodiment are computed, and the wall temperature is computed based on these values. The computation method is the same as that of the first embodiment.

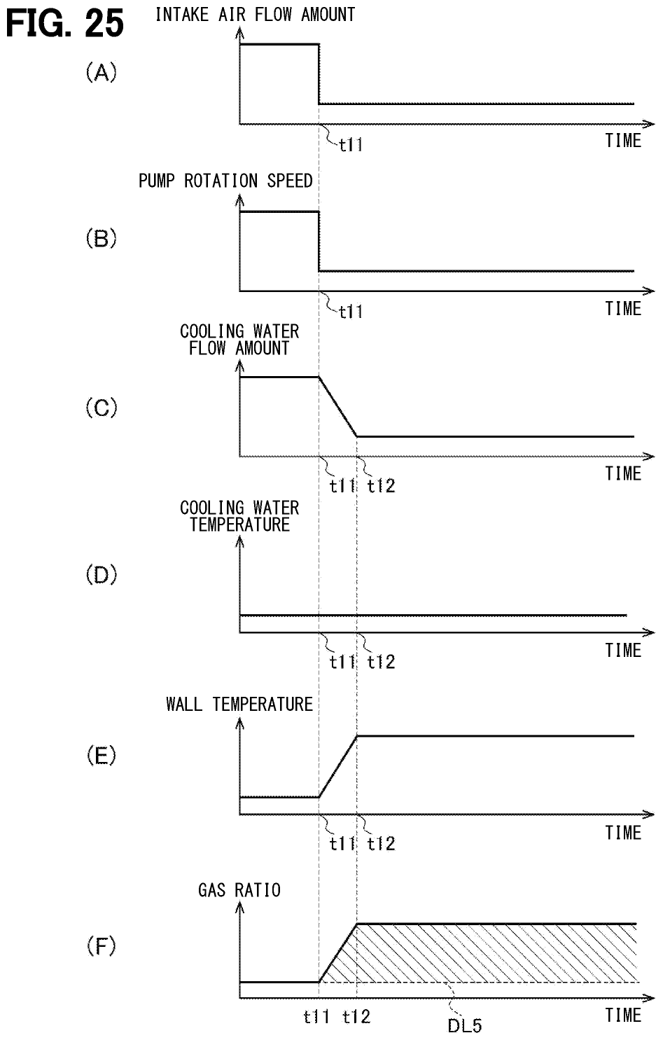

(A) in FIG. 25 shows an example of a time change of the flow amount of air passing through the intake pipe 270. (B) in FIG. 25 shows an example of a time change of the rotation speed of the water pump 340A. (C) in FIG. 25 shows an example of a time change of the flow amount of the cooling water passing through the internal combustion engine 200. (D) in FIG. 25 shows an example of a time change of the temperature of the cooling water passing through the internal combustion engine 200. (E) in FIG. 25 shows an example of a time change of the wall temperature. (F) in FIG. 25 shows an example of a time change of the gas ratio.

In the example of FIG. 25, at the time t11, the load of the internal combustion engine 200 changes from a high load to a low load. Along with this, switching from the low wall temperature control to the high wall temperature control is performed at the same time, and the flow amount of air passing through the intake pipe 270 is reduced.

As the high wall temperature control is started from the time t11, the rotation speed of the water pump 340A is reduced. Therefore, the flow amount of the cooling water decreases from the time t11 to the time t12, and becomes substantially constant after the time t12. On the other hand, the temperature of the cooling water passing through the internal combustion engine 200 is constant regardless of the rotation speed of the water pump 340A.

As described with reference to FIGS. 8 and 22, the wall temperature correlates with the flow amount and the temperature of the cooling water passing through the internal combustion engine 200. In the example of FIG. 25, in the period from the time t11 to the time t12, the wall temperature rises at a relatively high rate as the flow amount of the cooling water decreases. After the time t12, the wall temperature becomes constant as both the temperature and the flow amount of the cooling water become constant.

The ratio adjustment unit 130 changes the target value of the gas ratio in response to the increase in the wall temperature as described above. As in the example of FIG. 25, when the control is switched to the high wall temperature control, the ratio adjustment unit 130 performs the adjustment so that as the wall temperature becomes higher, the target value of the gas ratio becomes larger. Therefore, the gas ratio changes as shown by the solid line in (F) in FIG. 25. The value of the gas ratio adjusted in this way is substantially close to the ideal target value, that is, the value of the gas ratio at the combustion limit.

As described above, in a control according to an example, the target value of the gas ratio is set based on the temperature of the cooling water, not based on the wall temperature. In (F) in FIG. 25, the change in the gas ratio when the control according to the example is performed is shown by the dotted line DL5. Further, as is clear from the drawing, the value of the gas ratio shown by the dotted line DL5 is smaller than the value of the solid line, that is, the ideal target value. Therefore, in the control according to the example, although there is actually room for further increasing the gas ratio, the gas ratio is suppressed to a small value, and therefore, the fuel consumption rate in the internal combustion engine 200 would become high. The area of the portion indicated by the hatched line in (F) in FIG. 25 indicates an amount of improvement in the fuel consumption rate due to the control of the present embodiment.

Although description with reference to a drawing is omitted, in the control according to the example, the target value of the gas ratio that is set based on the temperature of the cooling water becomes a value larger than the ideal target value, contrary to the above configuration. Therefore, combustion in the internal combustion engine 200 may become unstable. To the contrary, according to the control of the present embodiment, the target value of the gas ratio does not exceed the ideal target value. Therefore, the configuration enables to regularly maintain the combustion in the internal combustion engine 200 stable.

As described above, even in the configuration according to the present embodiment, the same effect as that described in the first embodiment can be produced.

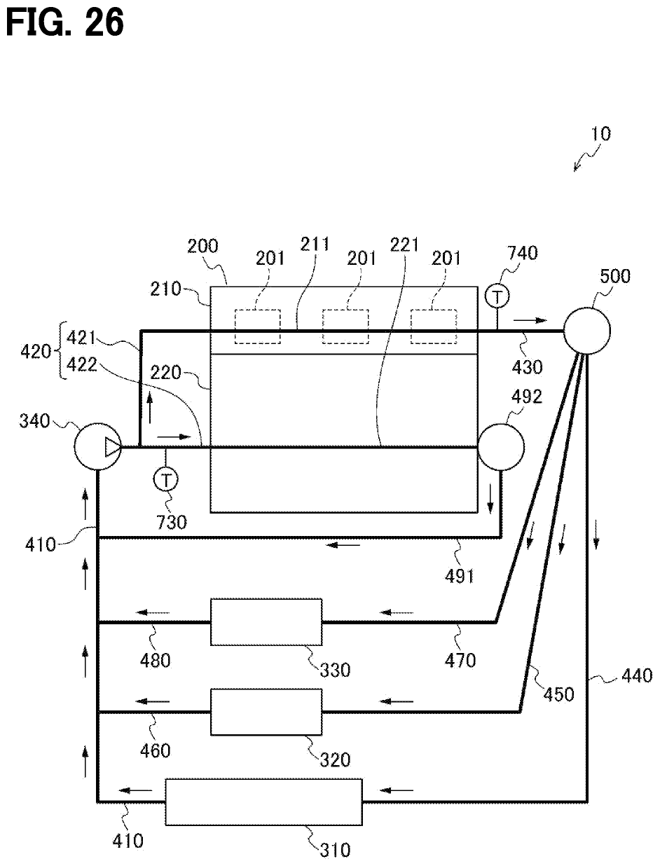

A third embodiment will be described. FIG. 26 schematically shows a configuration of the vehicle 10 according to the third embodiment. Hereinafter, only parts different from the first embodiment will be described, and description of parts common to the first embodiment will be omitted for brevity where appropriate.

In FIG. 26, only the configuration of the internal combustion engine 200 and the configuration related to the path for circulating the cooling water are schematically shown. A part of configurations of the intake pipe 270, the exhaust pipe 280, and the like are the same as those in the first embodiment and are omitted.

As shown in FIG. 26, the internal combustion engine 200 includes a head portion 210 and a block portion 220. The head portion 210 is a component that constitutes an upper portion of the internal combustion engine 200. The block portion 220 is a component that constitutes a lower portion of the internal combustion engine 200.

The dotted line with the reference numeral “201” in FIG. 26 schematically shows the shape of the combustion chamber formed in each cylinder 201. When a piston (not shown) is at or near the top dead center, that is, when fuel is burned, the combustion chamber, which is the space above the piston, is formed only inside the head portion 210 as shown in FIG. 26. In other words, the head portion 210 is a portion in which the combustion chamber is formed inside. On the other hand, in other words, the block portion 220 is a portion that accommodates a crankshaft, the piston, and the like (not shown) inside.

In the present embodiment, the pipe 420 extending from the water pump 340 to the internal combustion engine 200 is branched in midway portion and is divided into a pipe 421 and a pipe 422. An end of the pipe 421 is connected to the head portion 210, and an end of the pipe 422 is connected to the block portion 220. The inlet water temperature sensor 730 is provided at a position in a midway portion of the pipe 421 in the present embodiment.

Inside the head portion 210, a flow path 211 for passing the cooling water is formed. The pipe 421 is connected to an upstream end of the flow path 211. The pipe 430 extending to the flow control valve 500 is connected to a downstream end of the flow path 211.

A flow path 221 for passing the cooling water is formed inside the block portion 220. The pipe 422 is connected to an upstream end of the flow path 221. One end of a pipe 491 is connected to a downstream end of the flow path 221 through a thermostat 492. The other end of the pipe 491 is connected to the pipe 410. Thermostat 492 is a valve in which an opening degree is adjusted according to the temperature of the cooling water passing through the flow path 221. Thermostat 492 automatically adjusts the flow amount of the cooling water passing through the flow path 221, thereby to regularly maintain the temperature of the block portion 220 constant.

As described in the first embodiment, the wall temperature acquisition unit 110 computes and acquires the wall temperature based on the temperature of the cooling water acquired in step S11 of FIG. 10, specifically, the temperature of the cooling water measured by the outlet water temperature sensor 740. In the case of the present embodiment, the outlet water temperature sensor 740 measures the temperature of the cooling water after passing through the flow path 211 of the head portion 210. Therefore, the wall temperature computed based on this temperature is, in other words, substantially the temperature of the head portion 210.

As described above, the wall temperature acquisition unit 110 according to the present embodiment is configured to acquire, as the wall temperature, the temperature of the head portion 210, which is a portion of the internal combustion engine 200 in which the combustion chamber is formed.

The head portion 210 is a portion in which the combustion chamber is formed. Therefore, the temperature of the head portion 210 has a greater influence on the “gas ratio at the combustion limit” than the temperature of the block portion 220. Therefore, the configuration of the present embodiment, in which the temperature of the head portion 210 is acquired as the wall temperature and in which the gas ratio is adjusted based on the wall temperature, enables to cause the value of the gas ratio to be closer to the ideal target value.

It is noted that, as the configuration for acquiring the temperature of the head portion 210 as the wall temperature, a temperature sensor for directly acquiring the temperature of the head portion 210 may be provided to the head portion 210, and the temperature measured by the temperature sensor may be configured to be transmitted to the control device 100.

Further, the configuration for acquiring the wall temperature by providing the temperature sensor to the head portion 210 as described above may be employed in the first embodiment and the second embodiment as described above.

The present embodiments have been described with reference to specific examples above. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The combinations of elements included in each of the above described specific examples can be appropriately modified as long as no technical inconsistency occurs.

The control device and the control method thereof described in the present disclosure may be embodied with one or more special computer provided with at least one processor and at least one memory programmed to execute one or more functions embodied with a computer program. The control device and the control method described in the present disclosure may be embodied with a special computer provided with at least one processor that includes at least one special hardware logic circuit. The control device and the control method thereof described in the present disclosure may be embodied with at least one special computer provided with a combination of a processor and a memory programmed to implement one or more functions and at least one processor provided with at least one hardware logic circuit. The computer program may be stored, as instructions executable by a computer, in a tangible non-transitory computer-readable medium. The special hardware logic circuit and the hardware logic circuit may be embodied with a digital circuit including multiple logic circuits or may be embodied with an analog circuit.

What is claimed is:

1. A control device for an internal combustion engine, comprising:
a wall temperature acquisition unit configured to acquire a wall temperature of the internal combustion engine;
a wall temperature adjustment unit configured to adjust the wall temperature; and
a ratio adjustment unit configured to adjust a gas ratio, which is a ratio acquired by dividing a mass flow amount of gas supplied to the internal combustion engine by a mass flow amount of fuel supplied to the internal combustion engine, wherein
the wall temperature adjustment unit is configured to perform
a low wall temperature control to maintain the wall temperature at a low temperature when the internal combustion engine is operated at a high load and
a high wall temperature control to maintain the wall temperature at a high temperature when the internal combustion engine is operated at a low load, and
the ratio adjustment unit is configured to adjust the gas ratio based on the wall temperature acquired by the wall temperature acquisition unit, when switching between the low wall temperature control and the high wall temperature control is performed.

2. The control device according to claim 1, wherein
the wall temperature acquisition unit is configured to acquire the wall temperature based on a flow amount and a temperature of cooling water passing through the internal combustion engine.

3. The control device according to claim 1, wherein
the ratio adjustment unit is configured to adjust the gas ratio, so that as the wall temperature acquired by the wall temperature acquisition unit becomes lower, the gas ratio increases, when switching to the low wall temperature control is performed.

4. The control device according to claim 1, wherein
the ratio adjustment unit is configured to adjust the gas ratio, so that as the wall temperature acquired by the wall temperature acquisition unit becomes higher, the gas ratio increases, when switching to the high wall temperature control is performed.

5. The control device according to claim 1, wherein
the wall temperature acquisition unit is configured to acquire, as the wall temperature, a temperature of a head portion that is a portion of the internal combustion engine forming a combustion chamber therein.

6. A control device comprising:
a processor configured to:
acquire a wall temperature of an internal combustion engine;
perform a low wall temperature control to maintain the wall temperature at a low temperature when the internal combustion engine is operated at a high load;
perform a high wall temperature control to maintain the wall temperature at a high temperature when the internal combustion engine is operated at a low load; and
adjust a gas ratio based on the wall temperature, when switching between the low wall temperature control and the high wall temperature control is performed, wherein
the gas ratio is a ratio acquired by dividing a mass flow amount of gas supplied to the internal combustion engine by a mass flow amount of fuel supplied to the internal combustion engine.

7. A method implemented by a processor for controlling an internal combustion engine, comprising:
acquiring a wall temperature of the internal combustion engine;
performing a low wall temperature control to maintain the wall temperature at a low temperature when the internal combustion engine is operated at a high load;
performing a high wall temperature control to maintain the wall temperature at a high temperature when the internal combustion engine is operated at a low load; and
adjusting a gas ratio based on the wall temperature, when switching between the low wall temperature control and the high wall temperature control is performed, wherein
the gas ratio is a ratio acquired by dividing a mass flow amount of gas supplied to the internal combustion engine by a mass flow amount of fuel supplied to the internal combustion engine.
